(19) United States
(12) Patent Application Publication
(10) Pub. No.: US 2024/0188475 A1
(43) Pub. Date: Jun. 13, 2024

(54) AGRICULTURAL ASSISTANCE SYSTEM AND AGRICULTURAL ASSISTANCE METHOD

(71) Applicant: KUBOTA CORPORATION, Osaka (JP)

(72) Inventors: Yuki KUBOTA, Sakai-shi (JP); Toru TAMBO, Sakai-shi (JP); Itsuki OKUBO, Sakai-shi (JP); Kazuki OTA, Sakai-shi (JP)

(21) Appl. No.: 18/426,125

(22) Filed: Jan. 29, 2024

Related U.S. Application Data
(63) Continuation of application No. PCT/JP2022/013221, filed on Mar. 22, 2022.

(30) Foreign Application Priority Data
Jul. 30, 2021 (JP) 2021-125843

(51) Int. Cl. A01B 69/04

(52) U.S. Cl. CPC A01B 69/008

(57) ABSTRACT

An agricultural assistance system includes a controller configured or programmed to control an operation of one or more agricultural machines. In response to receiving from a terminal apparatus a signal requesting assistance in agricultural work for a field, the controller is configured or programmed to cause the one or more agricultural machines to move to the field to assist in the agricultural work for the field.

### CROSS REFERENCE TO RELATED APPLICATIONS

This application claims the benefit of priority to Japanese Patent Application No. 2021-125843 filed on Jul. 30, 2021 and is a Continuation Application of PCT Application No. PCT/JP2022/013221 filed on Mar. 22, 2022. The entire contents of each application are hereby incorporated herein by reference.

### BACKGROUND OF THE INVENTION

### 1. Field of the Invention

The present disclosure relates to agricultural assistance systems and agricultural assistance methods.

### 2. Description of the Related Art

Research and development has been directed to the automation of work vehicles such as tractors to be used in fields. For example, work vehicles which travel via automatic steering by utilizing a positioning system, e.g., a GNSS (Global Navigation Satellite System) that is capable of precise positioning, have come into practical use. Work vehicles which automatically perform not only automatic steering but also speed control have also come into practical use.

Japanese Laid-Open Patent Publication No. 2020-108407 and Japanese Laid-Open Patent Publication No. 2017-12134 each disclose a technique for achieving efficiency in agricultural work through cooperation of a plurality of work vehicles.

### SUMMARY OF THE INVENTION

According to the techniques disclosed in Japanese Laid-Open Patent Publication No. 2020-108407 and Japanese Laid-Open Patent Publication No. 2017-12134, as a plurality of work vehicles cooperate to perform work in a field, the work can be efficiently carried out. However, even in this case, the work progress may lag behind the task schedule, assistance in agricultural work may be necessary.

Example embodiments of the present invention provide techniques for facilitating assistance with the agricultural work of an agricultural machine for a field.

The present specification discloses solutions as recited in the following Items.

### Item 1

An agricultural assistance system to assist with agricultural work with one or more agricultural machines, the agricultural assistance system including a controller configured or programmed to control an operation of the one or more agricultural machines, wherein in response to receiving from a terminal apparatus a signal requesting assistance in agricultural work for a field, the controller is configured or programmed to cause the one or more agricultural machines to move to the field to assist in the agricultural work for the field.

### Item 2

The agricultural assistance system of Item 1, wherein the controller is configured or programmed to control an operation of a first agricultural machine among the one or more agricultural machines; and while a second agricultural machine is performing agricultural work in the field, in response to receiving the signal from the terminal apparatus, cause the first agricultural machine to move to the field to assist in the agricultural work performed by the second agricultural machine.

### Item 3

The agricultural assistance system of Item 1, wherein the controller is configured or programmed to control an operation of each of a first agricultural machine and a second agricultural machine among the one or more agricultural machines; and in response to receiving the signal from the terminal apparatus, cause the first agricultural machine and the second agricultural machine to move to the field to assist in the agricultural work for the field.

### Item 4

The agricultural assistance system of Item 2, wherein, in response to receiving the signal from the terminal apparatus, the controller is configured or programmed to cause the first agricultural machine being stopped in a storage location to move to the field, and after the agricultural work for the field is finished, cause the first agricultural machine to move to the storage location.

### Item 5

The agricultural assistance system of Item 2, wherein, in response to receiving the signal from the terminal apparatus, the controller is configured or programmed to cause the first agricultural machine being stopped in a first storage location to move to the field, and after the agricultural work for the field is finished, cause the first agricultural machine to move to a second storage location that is distinct from the first storage location.

### Item 6

The agricultural assistance system of Item 5, wherein, in response to receiving the signal from the terminal apparatus, the controller is configured or programmed to cause the first agricultural machine being stopped in the first storage location to move to the field, and after the agricultural work for the field is finished, cause the first agricultural machine to move to the second storage location being at a shorter distance from the field than a distance from the field to the first storage location.

### Item 7

The agricultural assistance system of Item 2, wherein the controller is configured or programmed to control an operation of a third agricultural machine among the one or more agricultural machines; and cause the first or third agricultural machine to move to the field based on a relative positioning, at a time when the signal is received from the terminal apparatus, between: a place where the first agricultural machine is located; a place where the third agricultural machine is located; and the field.

### Item 8

The agricultural assistance system of Item 7, wherein, when the first agricultural machine is stopped in a first storage location and the third agricultural machine is stopped in a second storage location that is located at a distance from the field that is greater than a distance from the field to the first storage location, in response to receiving the signal from the terminal apparatus, the controller is configured or programmed to cause the first agricultural machine to move from the first storage location to the field.

### Item 9

The agricultural assistance system of Item 7, wherein when the third agricultural machine is stopped in a first storage location and the first agricultural machine is performing agricultural work in another field that is located at a distance from the field that is less than a distance from the field to the first storage location, in response to receiving the signal from the terminal apparatus, the controller is configured or programmed to cause the first agricultural machine to move from the other field to the field.

### Item 10

The agricultural assistance system of Item 7, wherein, when the first agricultural machine is performing agricultural work in another field that is distinct from the field and the third agricultural machine is performing agricultural work in still another field that is located at a distance from the field that is greater than a distance from the field to the other field, in response to receiving the signal from the terminal apparatus, the controller is configured or programmed to cause the first agricultural machine to move from the other field to the field.

### Item 11

The agricultural assistance system of Item 1, further including a storage; wherein the controller is configured or programmed to generate a work log including at least one piece of information among contents of work, a task time, and a type of agricultural machine for the agricultural work performed by the one or more agricultural machines in the field, and to record the work log in the storage.

### Item 12

The agricultural assistance system of Item 11, wherein the controller is configured or programmed to transmit data of the work log to the terminal apparatus.

### Item 13

The agricultural assistance system of Item 11, wherein the controller is configured or programmed to calculate a rent for the one or more agricultural machines based on the work log, and transmit billing information to the terminal apparatus.

### Item 14

The agricultural assistance system of Item 1, wherein the controller is configured or programmed to manage a schedule of agricultural work to be performed by the one or more agricultural machines.

### Item 15

The agricultural assistance system of Item 14, wherein, when the controller determines that the one or more agricultural machines are to move to the field in response to receiving the signal from the terminal apparatus, the controller is configured or programmed to update a schedule of agricultural work to be performed by the one or more agricultural machines.

### Item 16

An agricultural assistance system to assist with agricultural work with an agricultural machine, the agricultural assistance system including a controller configured or programmed to control an operation of each of a first agricultural machine and a second agricultural machine; wherein the controller is configured or programmed to manage a schedule of agricultural work to be performed by the second agricultural machine; and while the second agricultural machine is performing agricultural work for the field, if it is determined that the agricultural work by the second agricultural machine is behind the schedule, cause the first agricultural machine to move to the field to assist in the agricultural work performed by the second agricultural machine.

### Item 17

A computer-implemented agricultural assistance method to assist with agricultural work with one or more agricultural machines, the agricultural assistance method causing a computer to control an operation of the one or more agricultural machines; receive a signal requesting assistance in agricultural work for a field that is transmitted from a terminal apparatus; and when receiving the signal, cause the one or more agricultural machines to move to the field to assist in the agricultural work for the field.

### Item 18

A computer-implemented agricultural assistance method to assist with agricultural work with an agricultural machine, the agricultural assistance method causing a computer to control an operation of each of a first agricultural machine and a second agricultural machine; manage a schedule of agricultural work to be performed by the second agricultural machine; and while the second agricultural machine is performing agricultural work for the field, if it is determined that the agricultural work by the second agricultural machine is behind the schedule, cause the first agricultural machine to move to the field to assist in the agricultural work performed by the second agricultural machine.

General or specific aspects of various example embodiments of the present disclosure may be implemented using a device, a system, a method, an integrated circuit, a computer program, a non-transitory computer-readable storage medium, or any combination thereof. The non-transitory computer-readable storage medium may be inclusive of a volatile storage medium, or a non-volatile storage medium. The device may include a plurality of devices. In the case where the device includes two or more devices, the two or more devices may be provided within a single apparatus, or divided over two or more separate apparatuses.

According to example embodiments of the present disclosure, it is possible to facilitate assistance with the agricultural work of an agricultural machine for a field.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram schematically showing an example configuration of an agricultural assistance system according to an illustrative example embodiment of the present invention.

FIG. 2 is a block diagram illustrating a schematic hardware configuration of a server computer.

FIG. 3 is a block diagram illustrating a schematic hardware configuration of a terminal apparatus.

FIG. 4 is a perspective view showing an example appearance of an agricultural machine according to an illustrative example embodiment of the present invention.

FIG. 5 is a side view schematically showing an example of an agricultural machine having an implement attached thereto.

FIG. 6 is a block diagram showing an example schematic configuration of an agricultural machine.

FIG. 7 is a conceptual diagram showing an example agricultural machine which performs positioning based on an RTK-GNSS.

FIG. 8 is a diagram schematically showing an example of an agricultural machine automatically traveling along a target path in a field.

FIG. 9 is a flowchart showing an example operation of steering control to be performed by a controller during self-driving.

FIG. 10A is a diagram showing an example of an agricultural machine that travels along a target path.

FIG. 10B is a diagram showing an example of an agricultural machine at a position which is shifted rightward from the target path.

FIG. 10C is a diagram showing an example of an agricultural machine at a position which is shifted leftward from the target path.

FIG. 10D is a diagram showing an example of an agricultural machine which is oriented in an inclined direction with respect to the target path.

FIG. 11 is a diagram schematically showing an example situation where a plurality of agricultural machines are self-traveling inside a field and on a road outside the field.

FIG. 12 is a diagram showing an example of a setting screen for a task schedule that is displayed on a display device of the terminal apparatus.

FIG. 13 is a diagram showing an example of a schedule of agricultural tasks to be generated by the server.

FIG. 14 is a flowchart showing a procedure of an example agricultural assistance method according to an illustrative example embodiment of the present invention.

FIG. 15A is a diagram for describing an overview of assistance in agricultural work for a field by an agricultural machine.

FIG. 15B is a diagram for describing an overview of assistance in agricultural work for a field by an agricultural machine.

FIG. 16 is a diagram for describing example operations of a controller of a first agricultural machine, a controller of a second agricultural machine, and a controller of the server.

FIG. 17 is a diagram illustrating a state where an administrator who is in the neighborhood of a field is using the terminal apparatus to manage the progress of work in the field that is performed by the second agricultural machine.

FIG. 18 is a diagram showing an example indication of progress of work to be displayed on a display of the terminal apparatus.

FIG. 19 is a diagram showing an example indication of a statement of usage to be displayed on the terminal apparatus after an agricultural work assistance service is used.

FIG. 20 is a diagram showing example operations of the controller of the first agricultural machine, the controller of the second agricultural machine, the terminal apparatus and the controller of the server where, in the case where assistance in the work of an agricultural machine is requested from the terminal apparatus being used by a user.

FIG. 21 is a diagram illustrating a state where an agricultural worker is performing manual work in the field while carrying the terminal apparatus.

FIG. 22 is a diagram showing example operations of the controller of the first agricultural machine, the terminal apparatus and the controller of the server in a case where the worker requests assistance in work by using the terminal apparatus.

FIG. 23 is a diagram illustrating a state in which the administrator being in the neighborhood of the field is using the terminal apparatus to manage the progress of work in the field performed by the second agricultural machine and in which the administrator is receiving assistance in the agricultural work by one or more agricultural machines.

FIG. 24A is a diagram for describing an example where, after agricultural work for the field is finished, the first agricultural machine is moved to a storage location that is distinct from the storage location in which the first agricultural machine was stopped.

FIG. 24B is a diagram for describing an example where, after agricultural work for the field is finished, the first agricultural machine is moved to a storage location that is distinct from the storage location in which the first agricultural machine was stopped.

FIG. 25 is a diagram showing another example where, after agricultural work for the field is finished, the first agricultural machine is moved to a storage location that is distinct from the storage location in which the first agricultural machine was stopped.

FIG. 26 is a diagram for describing an example where, in a case where the first storage location is closer to the field than is the second storage location, the agricultural machine at the first storage location is moved to the field.

FIG. 27 is a diagram for describing an example where, in a case where another field is closer to the field than is the storage location, an agricultural machine performing agricultural work in the other field is moved to the field.

FIG. 28 is a diagram for describing an example where, in a case where another field is closer to the field than is the storage location, an agricultural machine performing agricultural work in the other field is moved to the field.

FIG. 29 is a diagram for describing an example where, in a case where another field is closer to the field than is still another field, an agricultural machine performing agricultural work in the other field is moved to the field.

### DETAILED DESCRIPTION OF THE EXAMPLE EMBODIMENTS

Hereinafter, example embodiments of the present disclosure will be described more specifically. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims. In the following description, component elements having identical or similar functions are denoted by identical reference numerals.

The following example embodiments are only exemplary, and the techniques according to the present disclosure are not limited to the following example embodiments. For example, numerical values, shapes, materials, steps, and orders of steps, layout of a display screen, etc., that are indicated in the following example embodiments are only exemplary, and admit of various modifications so long as it makes technological sense. Any one implementation may be combined with another so long as it makes technological sense to do so.

In the present disclosure, an “agricultural machine” means a machine for agricultural applications. Examples of agricultural machines include tractors, harvesters, rice transplanters, vehicles for crop management, vegetable transplanters, mowers, seeders, spreaders, and mobile robots for use in fields. Not only may a work vehicle (such as a tractor) function as an “agricultural machine” alone by itself, but also an implement that is attached to or towed by a work vehicle may together in combination with the work vehicle function as an “agricultural machine”. For the ground surface within a field, an agricultural machine performs agricultural work such as tilling, seeding, preventive pest control, manure spreading, planting of crops, or harvesting. Such agricultural work or tasks may be referred to simply as “work” or “tasks”.

In the present disclosure, “self-driving” means controlling the movement of an agricultural machine by the action of a controller, rather than through manual operations of a driver.

An agricultural machine that performs self-driving may be referred to as a “self-driving agricultural machine” or a “robotic agricultural machine”. During self-driving, not only the movement of the agricultural machine, but also the operation of agricultural work may also be controlled automatically. In the case where the agricultural machine is a vehicle-type machine, traveling of the agricultural machine via self-driving will be referred to as “self-traveling”. The controller may control at least one of: steering that is required in the movement of the agricultural machine; adjustment of the moving speed; and beginning and ending a move. In the case of controlling a work vehicle having an implement attached thereto, the controller may control operations such as raising or lowering of the implement, beginning and ending of an operation of the implement, and so on. A move based on self-driving may include not only moving of an agricultural machine that goes along a predetermined path toward a destination, but also moving of an agricultural machine that follows a target of tracking. An agricultural machine that performs self-driving may also have the function of moving partly based on the user's instructions. Moreover, an agricultural machine that performs self-driving may operate not only in a self-driving mode but also in a manual driving mode, where the agricultural machine moves through manual operations of the driver. When performed not manually but through the action of a controller, the steering of an agricultural machine will be referred to as “automatic steering”. A portion or an entirety of the controller may reside outside the agricultural machine. Control signals, commands, data, etc., may be communicated between the agricultural machine and a controller residing outside the agricultural machine. An agricultural machine that performs self-driving may move autonomously while sensing the surrounding environment, without any person being involved in the controlling of the movement of the agricultural machine. An agricultural machine that is capable of autonomous movement is able to travel within the field or outside the fields (e.g., on roads) in an unmanned manner. During an autonomous move, operations of detecting and avoiding obstacles may be performed.

An agricultural assistance system according to an example embodiment of the present disclosure is, in effect, realized as a computer system. The agricultural assistance system includes a controller configured or programmed to control an operation of one or more agricultural machines. By using the agricultural assistance system, the user is able to enjoy an agricultural work assistance service. Examples of agricultural work assistance services include agricultural machine sharing services. In response to receiving from a terminal apparatus a signal requesting assistance in agricultural work for a field, the controller is configured or programmed to cause the one or more agricultural machines to move to the field to assist in the agricultural work for the field. In the following description, a signal requesting assistance in agricultural work may be referred to as a “request signal”.

The controller may be a computer that includes one or more processors and one or more memories, for example. In that case, the processor may consecutively execute a computer program that is stored in the memory(s) to achieve a desired process. The controller may be mounted on the agricultural machine, or disposed at a place that is remote from the agricultural machine, e.g., at the home or the office of a user who monitors the agricultural machine or a management center that manages the agricultural machine. One of multiple electronic control units (ECU) that is mounted on the agricultural machine may function as the controller, or an ECU that is mounted on one of a plurality of agricultural machines may be designated as a master computer to function as the controller. Alternatively, an external server computer or an edge computer that communicates with the agricultural machine via a network may function as the controller. Furthermore, a terminal apparatus may function as the controller. Examples of terminal apparatuses include stationary type computers, smartphones, tablet computers, laptop computers, or the like.

A controller according to an aspect of an example embodiment of the present disclosure is configured or programmed to control an operation of a first agricultural machine among the one or more agricultural machines, and, while a second agricultural machine is performing agricultural work in a field, in response to receiving a request signal from a terminal apparatus that is used by the user, cause the first agricultural machine to move to the field to assist in the agricultural work performed by the second agricultural machine. Alternatively, the controller may be configured or programmed to control an operation of each of a first agricultural machine and a second agricultural machine among the one or more agricultural machines, and, in response to receiving a request signal from a terminal apparatus that is used by the user, cause the first agricultural machine and the second agricultural machine to move to the field to assist in the agricultural work for the field.

When an agricultural worker performs manual work in a field, or manually manipulates an agricultural machine to perform agricultural work, the progress of work may lag behind the initially-conceived task schedule. Even in the case where an agricultural machine performs agricultural work through unmanned self-driving in accordance with a task schedule that was made by an agricultural worker, the progress of work may lag behind the initially-conceived task schedule because of various factors, e.g., the field state, changing weather, deteriorations in the parts of the agricultural machine, or deteriorations of an implement. For example, tasks such as rice planting or harvesting need to be performed in an intensive manner over a short period of time, and delays in the task schedule are more likely to occur as the area of the field increases. Conventionally, when a delay in the task schedule occurs, for example, an administrator who manages the entirety of agricultural work (e.g., a farm owner) can communicate with one or more workers to request the worker(s) for assistance in the agricultural work. The requested worker(s) can assist in the agricultural work via manual work, or with an agricultural machine that the administrator possesses. However, assistance in the agricultural work may be requested to no more than the workers who are hired by the administrator, etc. Furthermore, because an agricultural machine is in the possession of an individual such as the administrator, when others wish to use that agricultural machine, permission needs to be obtained through negotiations, etc.

According to an example embodiment of the present disclosure, even if a delay in a task schedule occurs, assistance in the agricultural work can be received from an agricultural machine(s) to facilitate recovery from the lag. For example, a plurality of agricultural machines each belonging to a different owner may be connected to the agricultural assistance system, whereby sharing of an agricultural machine between different groups can be realized, etc. This allows an agricultural worker belonging to one group to request an agricultural machine belonging to another group to provide assistance in the agricultural work.

However, requests for assistance from the user are not limited to the case where a delay in the task schedule has occurred. The user may arbitrarily make a request for assistance in agricultural work, e.g., in order to accelerate the agricultural work to expedite the task schedule.

According to another aspect of an example embodiment of the present disclosure, while an agricultural worker is performing manual work in the field, in response to receiving a request signal from a terminal apparatus that is used by the agricultural worker, the controller may be configured or programmed to cause an agricultural machine to move to the field to assist in the manual work by the agricultural worker. In this example, too, recovery from the lag is facilitated by assistance in agricultural work by the agricultural machine.

According to still another aspect of an example embodiment of the present disclosure, the controller is configured or programmed to control the operation of each of the first agricultural machine and the second agricultural machine. The controller is configured or programmed to manage a schedule of agricultural work to be performed by the second agricultural machine, and, while the second agricultural machine is performing agricultural work for the field, if it is determined that the agricultural work by the second agricultural machine is behind the schedule, cause the first agricultural machine to move to the field to assist in the agricultural work performed by the second agricultural machine. According to this example, a technique for fully automating assistance in agricultural work for the field by a self-driving agricultural machine may be provided.

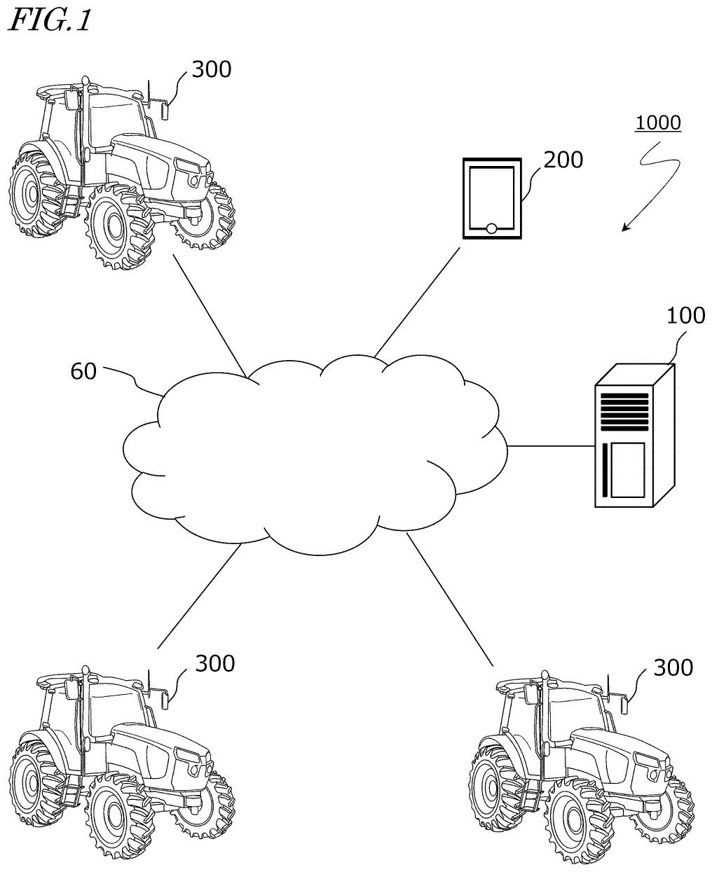

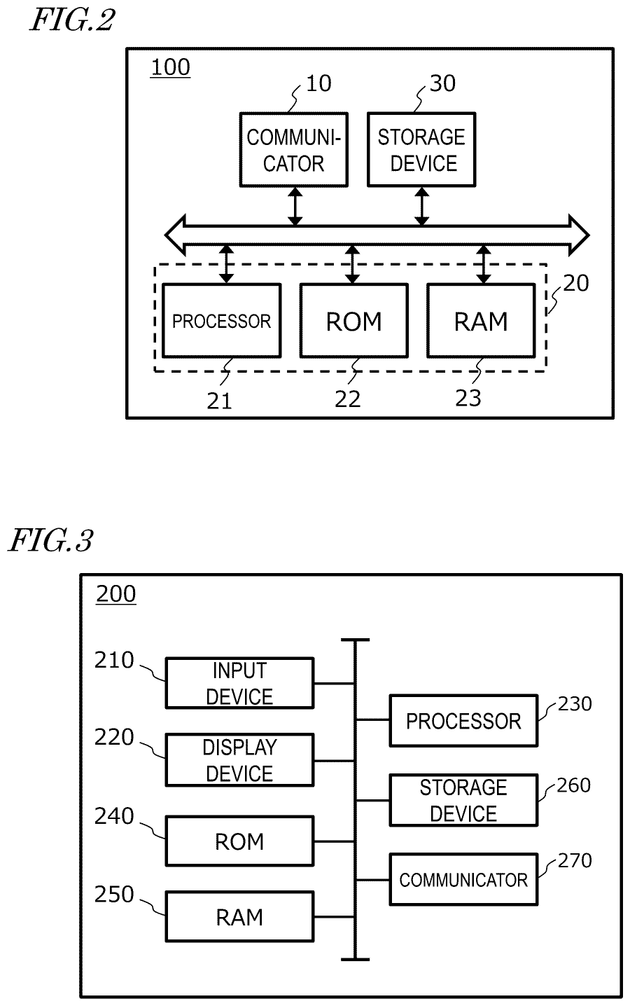

FIG. 1 is a diagram schematically showing an example configuration of an agricultural assistance system 1000 according to the present example embodiment. FIG. 2 is a block diagram illustrating a schematic hardware configuration of a server computer 100. The agricultural assistance system 1000 includes a server computer 100 (hereinafter denoted as the “server 100”) and one or more terminal apparatuses 200. Via a wired or wireless network 60, the plurality of agricultural machines 300 may be connected to the agricultural assistance system 1000 in such a manner that they are capable of communicating with one another. FIG. 1 shows an example connection where three agricultural machines 300 are connected to the agricultural assistance system 1000 via the network 60. However, any number of agricultural machines 300 may be connected to the agricultural assistance system 1000. From the standpoint of reducing communication delays and dispersing the network load, the agricultural assistance system 1000 may further include one or more edge computers. In the present example embodiment, a portion of the server 100 is configured or programmed to function as a controller.

To the agricultural assistance system 1000, for example, a plurality of agricultural machines that are possessed by an administrator may be connected. Alternatively, a plurality of agricultural machines each belonging to a different administrator may be connected to the agricultural assistance system 1000.

The server 100 may be a computer that is disposed at a remote place from the agricultural machine 300. The server 100 includes a communicator 10, a controller 20, and a storage device 30. These component elements are connected to one another via a bus so as to be capable of communicating with another. The server 100 can be configured or programmed to function as a cloud server that processes request signals, manage a schedule of agricultural tasks to be performed by agricultural machines 300, and assist in agriculture by using data that is stored in a storage.

The communicator 10 is a communication module to communicate with the terminal apparatus 200 and the agricultural machines 300 via the network 60. For example, the communicator 10 is able to perform wired communications compliant with communication standards such as IEEE 1394 (registered trademark) or Ethernet (registered trademark). For example, the communicator 10 is able to perform wireless communications compliant with the Bluetooth (registered trademark) standards or the Wi-Fi standards, or 3G, 4G, 5G or other cellular mobile communications.

The controller 20 includes a processor 21, a ROM (Read Only Memory) 22, a RAM (Random Access Memory) 23, and the like, for example. Software (or firmware) for the processor 21 to perform at least one process may be implemented in the ROM 22. Such software may be recorded on a computer-readable storage medium, e.g., an optical disc, and marketed as packaged software, or provided to the user via the network 60.

The processor 21 is a semiconductor integrated circuit, and includes a central processing unit (CPU). The processor 21 may be realized as a microprocessor or microcontroller. The processor 21 consecutively executes a computer program stored in the ROM 22, in which instructions for executing at least one process are described, to realize desired processes.

In addition to or instead of the processor 21 the controller 20 may include an FPGA (Field Programmable Gate Array), a GPU (Graphics Processing Unit), an ASIC (Application Specific Integrated Circuit), an ASSP (Application Specific Standard Product) having a CPU mounted therein, or a combination of two or more circuits selected from among such circuits.

The ROM 22 is a writable memory (e.g., a PROM), a rewritable memory (e.g., a flash memory), or a read-only memory, for example. The ROM 22 stores a program executable to control the operation of the processor 21. The ROM 22 may not be a single storage medium, but may be a set of storage media. A portion of the set of storage media may be removable memory.

The RAM 23 provides a work area into which the control program stored in the ROM 22 will be temporarily laid out during boot-up. The RAM 23 may not necessarily be a single storage medium, and may be a set of storage media.

The storage device 30 mainly functions as a storage for databases. An example of the storage device 30 is a cloud storage. The storage device 30 may be a magnetic storage device or a semiconductor storage device, for example. An example of a magnetic storage device is a hard disk drive (HDD). An example of a semiconductor storage device is a solid state drive (SSD). However, the storage device3 0 may be an external storage device that is connected to the server 100 via the network 60.

FIG. 3 is a block diagram illustrating a schematic hardware configuration of the terminal apparatus 200.

The terminal apparatus 200 includes an input device 210, a display device 220, a processor 230, a ROM 240, a RAM 250, a storage device 260, and a communicator 270. These component elements are connected to one another via a bus so as to be capable of communicating with another.

The input device 210 is a device that converts instructions from the user into data and inputs it to a computer. Examples of the input device 210 are a keyboard, a mouse, and a touchscreen panel. Examples of the display device 220 are a liquid crystal display and an organic EL display. The description of each of the processor 230, the ROM 240, the RAM 250, the storage device 260, and the communicator 270 has already been given in the hardware configuration example of the server 100, and is omitted.

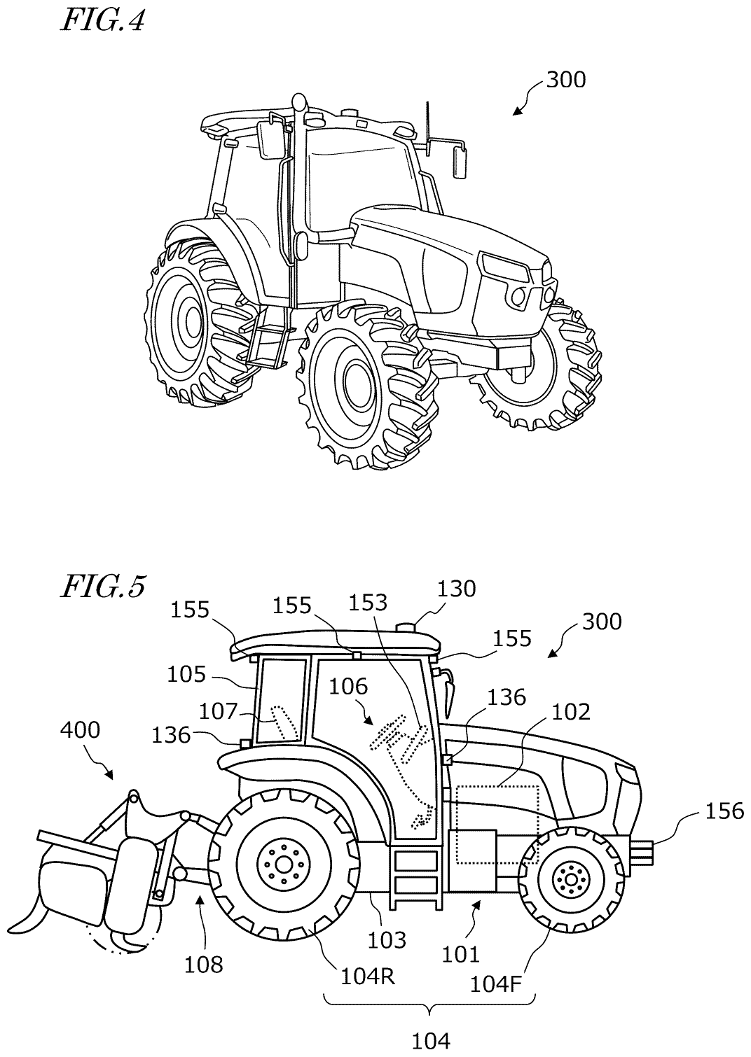

FIG. 4 is a perspective view showing an example appearance of the agricultural machine 300 according to the present example embodiment. FIG. 5 is a side view schematically showing an example of the agricultural machine 300 having an implement 400 attached thereto. The agricultural machine 300 according to the present example embodiment is an agricultural tractor (work vehicle) having the implement 400 attached thereto. The agricultural machine 300 is not limited to a tractor, and may not have the implement 400 attached thereto.

As shown in FIG. 5, the agricultural machine 300 includes a vehicle body 101, a prime mover (engine) 102, and a transmission 103. On the vehicle body 101, tires (wheels) 104 and a cabin 105 are provided. The tires 104 include a pair of front wheels 104F and a pair of rear wheels 104R. Inside the cabin 105, a driver's seat 107, a steering device 106, an operational terminal 153, and switches for manipulation are provided. In the case where the agricultural machine 300 does not travel on public roads, either pair of the front wheels 104F or the rear wheels 104R may be crawlers, rather than tires.

The agricultural machine 300 shown in FIG. 5 further includes a plurality of cameras 155. The cameras 155 may be provided at the front/rear/right/left of the agricultural machine 300, for example. The cameras 155 capture images of the surrounding environment of the agricultural machine 300, and generate image data. The images acquired by the cameras 155 may be transmitted to the terminal apparatus 200 which is responsible for remote monitoring. The images may be used to monitor the agricultural machine 300 during unmanned driving. The cameras 155 may also be used in order to generate images for recognizing white lines, signs, indications, or obstacles in the surroundings when the agricultural machine 300 travels on a road.

The agricultural machine 300 further includes the positioning device 130. The positioning device 130 includes a GNSS receiver. The GNSS receiver includes an antenna to receive a signal(s) from a GNSS satellite(s) and a processing circuit to determine the position of the agricultural machine 300 based on the signal(s) received by the antenna. The positioning device 130 receive a GNSS signal(s) transmitted from a GNSS satellite(s), and performs positioning on the basis of the GNSS signal(s). GNSS is a general term for satellite positioning systems, such as GPS (Global Positioning System), QZSS (Quasi-Zenith Satellite System, e.g., MICHIBIKI), GLONASS, Galileo, BeiDou, and the like. Although the positioning device 130 in the present example embodiment is disposed above the cabin 105, it may be disposed at any other position.

The positioning device 130 may include an inertial measurement unit (IMU). It is possible to complement the position data by using a signal from the IMU. The IMU can measure tilts and minute motions of the agricultural machine 300. By complementing the position data based on satellite signals using the data acquired by the IMU, the positioning performance can be improved.

The agricultural machine 300 illustrated in FIG. 5 further includes an LiDAR sensor 156. The LiDAR sensor 156 in this example is The LiDAR sensor 156 in this example is disposed at a lower portion of the front surface of the vehicle body 101. The LiDAR sensor 156 may alternatively be disposed at other positions. While the agricultural machine 300 is moving, the LiDAR sensor 156 repetitively outputs sensor data representing the distances and directions of measurement points on objects existing in the surrounding environment, or two-dimensional or three-dimensional coordinate values of such measurement points. The sensor data which is output from the LiDAR sensor 156 is processed by the controller of the agricultural machine 300. By utilizing SLAM (Simultaneous Localization and Mapping) or other algorithms, for example, the controller is able to perform processes such as generating an environment map based on the sensor data. The generation of an environment map may be performed by a computer, e.g., the server 100, that is external to the agricultural machine 300. The sensor data that is output from the LiDAR sensor 156 may also be utilized for obstacle detection.

The positioning device 130 may utilize the data acquired by the cameras 155 or the LiDAR sensor 156 for positioning. When objects serving as characteristic points exist in the environment that is traveled by the agricultural machine 300, the position of the agricultural machine 300 can be estimated with a high accuracy based on data that is acquired with the cameras 155 or the LiDAR sensor 156 and an environment map that is previously recorded in the storage device. By correcting or complementing position data based on the satellite signal(s) using the data acquired by the cameras 155 or the LiDAR sensor 156, it becomes possible to identify the position of the agricultural machine 300 with a higher accuracy.

The agricultural machine 300 further includes a plurality of obstacle sensors 136. In the example shown in FIG. 5, the obstacle sensors 136 are provided at the front and the rear of the cabin 105. The obstacle sensors 136 may be used to detect obstacles in the surroundings during self-traveling to come to a halt or detour around it.

The prime mover 102 may be a diesel engine, for example. Instead of a diesel engine, an electric motor may be used. The transmission 103 can change the propulsion and the moving speed of the agricultural machine 300 through a speed changing mechanism. The transmission 103 can also switch between forward travel and backward travel of the agricultural machine 300.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as “steering angle”) can cause a change in the traveling direction of the agricultural machine 300. The steering angle of the front wheels 104F can be changed by manipulating the steering wheel. The power steering device includes a hydraulic device or an electric motor to supply an assisting force to change the steering angle of the front wheels 104F. When automatic steering is performed, under the control of a controller disposed in the agricultural machine 300, the steering angle may be automatically adjusted by the power of the hydraulic device or electric motor.

A linkage device 108 is provided at the rear of the vehicle body 101. The linkage device 108 may include, e.g., a three-point linkage (also referred to as a “three-point link” or a “three-point hitch”), a PTO (Power Take Off) shaft, a universal joint, and a communication cable. The linkage device 108 allows the implement 400 to be attached to or detached from the agricultural machine 300. While towing the implement 400, the agricultural machine 300 allows the implement 400 to perform a predetermined task. The linkage device 108 may be provided frontward of the vehicle body 101. In that case, the implement may be connected frontward of the agricultural machine 300.

Although the agricultural machine 300 illustrated in FIG. 5 is a rotary tiller, the implement 400 is not limited to a rotary tiller. For example, any arbitrary implement such as a seeder, a spreader, a transplanter, a mower, a harvester, a sprayer, or a harrow, may be connected to the agricultural machine 300 for use.

The agricultural machine 300 illustrated in FIG. 5 is capable of human driving. Alternatively, it may only support unmanned driving. In that case, component elements which are only required for human driving, e.g., the cabin 105, the steering device 106, and the driver's seat 107 do not need to be provided in the agricultural machine 300. An unmanned agricultural machine 300 may travel via autonomous driving, or by remote manipulation by a user.

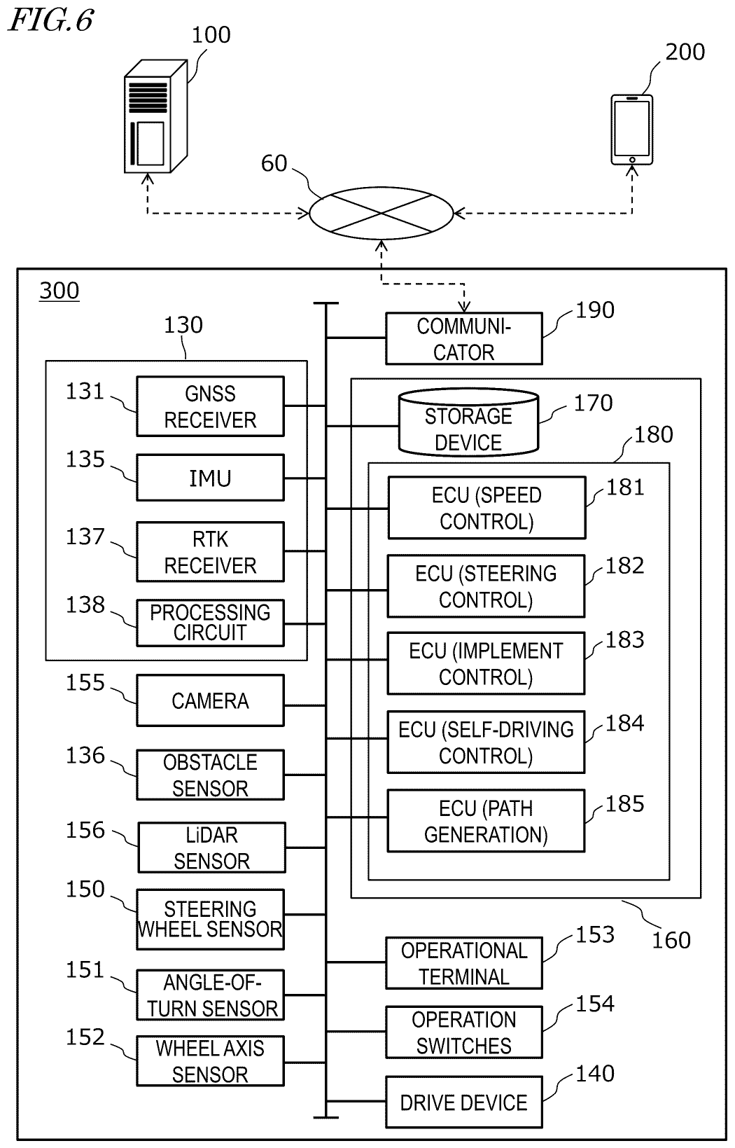

FIG. 6 is a block diagram showing an example schematic configuration of the agricultural machine 300. The agricultural machine 300 and the implement 400 can communicate with each other via a communication cable that is included in the linkage device 108.

In addition to the cameras 155, the positioning device 130, the obstacle sensors 136, and the operational terminal 153, the agricultural machine 300 in the example of FIG. 6 includes a drive device 140, steering wheel sensor 150, an angle-of-turn sensor 151, a wheel axis sensor 152, operation switches 154, a control system 160, and a communicator 190.

The positioning device 130 includes a GNSS receiver 131, and an inertial measurement unit 135. The control system 160 includes a storage device 170 and a controller 180. The controller 180 includes a plurality of electronic control units 181 to 185. Note that FIG. 6 shows component elements which are relatively closely related to the operations of self-driving by the agricultural machine 300, while other component elements are omitted from illustration.

The GNSS receiver 131 in the positioning device 130 receive satellite signals which are transmitted from multiple GNSS satellites, and generate GNSS data based on the satellite signals. The GNSS data may be generated in a predetermined format, such as the NMEA-0183 format, for example. The GNSS data may include values representing the identification number, angle of elevation, azimuth angle, and reception intensity of each satellite from which a satellite signal was received, for example.

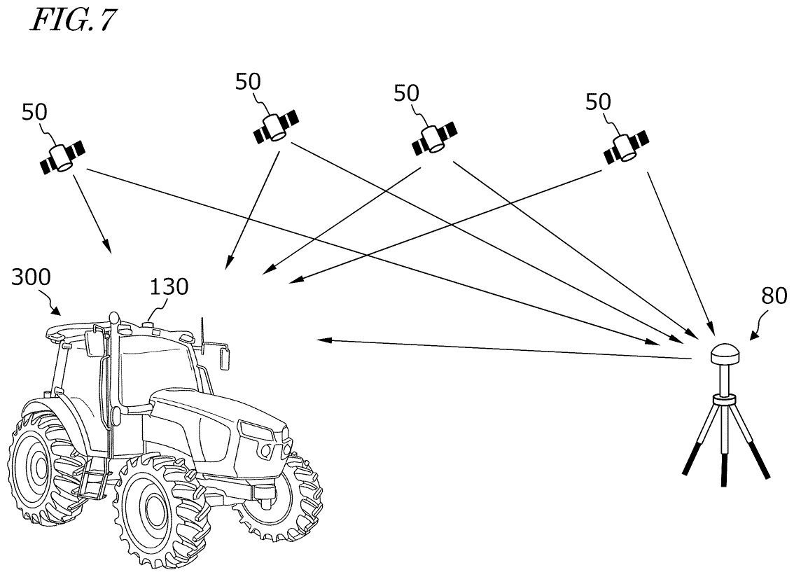

The positioning device 130 shown in FIG. 6 performs positioning of the agricultural machine 300 by utilizing an RTK (Real Time Kinematic)-GNSS. FIG. 7 is a conceptual diagram showing an example of the agricultural machine 300 which performs positioning based on an RTK-GNSS. In the positioning based on an RTK-GNSS, not only satellite signals transmitted from multiple GNSS satellites 50, but also a correction signal that is transmitted from a reference station 80 is used. The reference station 80 may be disposed near the field that is traveled by the agricultural machine 300 (e.g., at a position within 1 km of the agricultural machine 300). The reference station 80 generates a correction signal of, e.g., an RTCM format based on the satellite signals received from the multiple GNSS satellites 50, and transmits the correction signal to the positioning device 130. The RTK receiver 137, which includes an antenna and a modem, receives the correction signal transmitted from the reference station 80. Based on the correction signal, the processing circuit 138 of the positioning device 130 corrects the result of positioning by the GNSS receiver 131. Use of an RTK-GNSS enables positioning with an accuracy on the order of several cm of errors, for example. Positional information (including latitude, longitude, and altitude information) is acquired through the highly accurate positioning by an RTK-GNSS. The positioning device 130 may calculate the position of the agricultural machine 300 as frequently as, e.g., one to ten times per second.

Note that the positioning method is not limited to an RTK-GNSS. Any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System). In the case where positional information with the necessary accuracy can be obtained without the use of the correction signal transmitted from the reference station 80, positional information may be generated without using the correction signal. In that case, the positioning device 130 may lack the RTK receiver 137.

The positioning device 130 in the present example embodiment further includes an IMU 135. The IMU 135 includes a 3-axis accelerometer and a 3-axis gyroscope. The IMU 135 may include a direction sensor such as a 3-axis geomagnetic sensor. The IMU 135 functions as a motion sensor which can output signals representing parameters such as acceleration, velocity, displacement, and attitude of the agricultural machine 300. Based not only on the GNSS signals and the correction signal but also on a signal that is output from the IMU 135, the positioning device 130 can estimate the position and orientation of the agricultural machine 300 with a higher accuracy. The signal that is output from the IMU 135 may be used for the correction or complementation of the position that is calculated based on the satellite signals and the correction signal. The IMU 135 outputs a signal more frequently than does the GNSS receiver 131. Utilizing this highly frequent signal, the processing circuit 138 can measure the position and orientation of the agricultural machine 300 more frequently (e.g., about 10 Hz or above). Instead of the IMU 135, a 3-axis accelerometer and a 3-axis gyroscope may be separately provided. The IMU 135 may be provided as a separate device from the positioning device 130.

In the example of FIG. 6, the processing circuit 138 calculates the position of the agricultural machine 300 based on signals which are output from the GNSS receiver 131, the RTK receiver 137, and the IMU 135. Furthermore, the processing circuit 138 may estimate or correct the position of the agricultural machine 300 based on data that is acquired by the cameras 155 or the LiDAR sensor 156. By using the data acquired by the cameras 155 or the LiDAR sensor 156, the accuracy of positioning can be further enhanced.

The positional calculation may instead be performed by any device other than the positioning device 130. For example, the controller 180 or an external computer may acquire output data from the each receiver and each sensor as is required for positioning, and estimate the position of the agricultural machine 300 based on such data.

The cameras 155 are imagers that image the surrounding environment of the agricultural machine 300. Each camera 155 may include an image sensor such as a CCD (Charge Coupled Device) or a CMOS (Complementary Metal Oxide Semiconductor), for example. In addition, each camera 155 may include an optical system including one or more lenses and a signal processing circuit. During travel of the agricultural machine 300, the cameras 155 image the surrounding environment of the agricultural machine 300, and generate image (e.g., motion picture) data. The cameras 155 are able to capture motion pictures at a frame rate of 3 frames/second (fps: frames per second) or greater, for example. The images generated by the cameras 155 may be used when a remote supervisor checks the surrounding environment of the agricultural machine 300 with the terminal apparatus 200, for example. The images generated by the cameras 155 may also be used for the purpose of positioning or obstacle detection. As shown in FIG. 5, a plurality of cameras 155 may be provided at different positions on the agricultural machine 300, or a single camera may be provided. A visible camera(s) for generating visible images and an infrared camera(s) for generating infrared images may be separately provided. Both of a visible camera(s) and an infrared camera(s) may be provided as cameras for generating images for monitoring purposes. Infrared cameras may also be used for obstacle detection at nighttime.

The obstacle sensors 136 detect objects around the agricultural machine 300. Each obstacle sensor 136 may include a laser scanner or an ultrasonic sonar, for example. When an object exists at a position closer to the obstacle sensor 136 than a predetermined distance, the obstacle sensor 136 outputs a signal indicating the presence of an obstacle. A plurality of obstacle sensors 136 may be provided at different positions of the agricultural machine 300. For example, a plurality of laser scanners and a plurality of ultrasonic sonars may be disposed at different positions of the agricultural machine 300. Providing a multitude of obstacle sensors 136 can reduce blind spots in monitoring obstacles around the agricultural machine 300.

The drive device 140 includes various devices that are needed for the traveling of the agricultural machine 300 and the driving of the implement 400, e.g., the aforementioned prime mover 102 and transmission 103, a differential including a locking differential mechanism, the steering device 106, and the linkage device 108, for example. The prime mover 102 may include an internal combustion engine such as a diesel engine. Instead of an internal combustion engine or in addition to an internal combustion engine, the drive device 140 may include an electric motor that is dedicated to traction purposes.

The steering wheel sensor 150 measures the angle of rotation of the steering wheel of the agricultural machine 300. The angle-of-turn sensor 151 measures the angle of turn of the front wheels 104F, which are the wheels responsible for steering. Measurement values by the steering wheel sensor 150 and the angle-of-turn sensor 151 are used for steering control by the controller 180.

The wheel axis sensor 152 measures the rotational speed, i.e., the number of revolutions per unit time, of a wheel axis that is connected to a tire 104. The wheel axis sensor 152 may be a sensor utilizing a magnetoresistive element (MR), a Hall generator, or an electromagnetic pickup, for example. The wheel axis sensor 152 may output a numerical value indicating the number of revolutions per minute (unit: rpm) of the wheel axis, for example. The wheel axis sensor 152 is used to measure the speed of the agricultural machine 300.

The storage device 170 includes one or more storage media such as a flash memory or a magnetic disc. The storage device 170 stores various data that is generated by the sensors and by the controller 180. In the storage device 170, an environment map including the inside of the field and any public roads outside the field and information of target paths are previously recorded. In the case where one or more of a plurality of ECUs included in the controller 180 function(s) as the controller 20 according to the present example embodiment, a schedule of agricultural tasks to be performed by the agricultural machine 300, data of a work log, billing information, and the like may be stored in the storage device 170, for example.

The controller 180 includes a plurality of ECUs. The plurality of ECUs may include, for example, an ECU 181 for speed control, an ECU 182 for steering control, an ECU 183 for implement control, an ECU 184 for self-driving control, and an ECU 185 for path generation, for example. The ECU 181 controls the prime mover 102, the transmission 103, and the brakes included in the drive device 140, thus controlling the speed of the agricultural machine 300. The ECU 182 controls the hydraulic device or electric motor included in the steering device 106 based on a measurement value of the steering wheel sensor 150, thus controlling the steering of the agricultural machine 300. In order to cause the implement 400 to perform a desired operation, the ECU 183 controls the operation of the three-point link, the PTO shaft, etc., that are included in the linkage device 108. Also, the ECU 183 generates a signal to control the operation of the implement 400, and transmits this signal from the communication device 190 to the implement 400. Based on signals which are output from the positioning device 130, the steering wheel sensor 150, the angle-of-turn sensor 151, and the wheel axis sensor 152, the ECU 184 performs computation and control for achieving self-driving. During self-driving, the ECU 184 sends a speed command value to the ECU 181, and sends a steering angle command value to the ECU 182. In response to the speed command value, the ECU 181 controls the prime mover 102, the transmission 103, or the brakes to change the speed of the agricultural machine 300. In response to the steering angle command value, the ECU 182 controls the steering device 106 to change the steering angle. The ECU 185 controls communications of the communicator 190 with other devices. For example, the ECU 185 generates a target path for the agricultural machine 300, and records it to the storage device 170.

When the controller 20 of the server 100, upon receiving a request for assistance in agricultural work, determines that an agricultural machine 300 stopped in a storage location, for example, is to assist in the agricultural work for the field, the ECU 185 may receive the positional information of the field needing assistance that is transmitted from the controller 20, and generate a target path from the current point to the field needing assistance based on the received positional information, for example.

Through the action of these ECUs, the controller 180 achieves self-driving, determination of a target path, and communications with other devices. During self-driving, the controller 180 controls the drive device 140 based on the position of the agricultural machine 300 as measured or estimated by the positioning device 130 and the target path stored in the storage device 170. As a result, the controller 180 causes the agricultural machine 300 to travel along the target path.

The plurality of ECUs included in the controller 180 may communicate with one another according to a vehicle bus standard such as CAN (Controller Area Network). Although the ECUs 181 to 185 are illustrated as individual corresponding blocks in FIG. 6, each of these functions may be implemented by a plurality of ECUs. Alternatively, an onboard computer that integrates the functions of at least some of the ECUs 181 to 185 may be provided. The controller 180 may include ECUs other than the ECUs 181 to 185, and any number of ECUs may be provided in accordance with functionality. For example, the controller 180 may further include an ECU to be used for managing access of the agricultural machine 300 to a field. Each ECU includes a control circuit including one or more processors.

The communication device 190 includes a circuit that performs communications with the communication IF of the implement 400. The communication device 190 includes circuitry to perform exchanges of signals complying with an ISOBUS standard such as ISOBUS-TIM, for example, between itself and the communication IF of the implement 400. This causes the implement 400 to perform a desired operation, or allows information to be acquired from the implement 400.

The operational terminal 153 is a terminal for the user to perform a manipulation related to the traveling of the agricultural machine 300 and the operation of the implement 400, and may also be referred to as a virtual terminal (VT). The operational terminal 153 may include a display device such as a touch screen panel, and/or one or more buttons. The display device may be a display such as a liquid crystal or an organic light-emitting diode (OLED), for example. By manipulating the operational terminal 153, the user can perform various manipulations, such as switching ON/OFF the self-driving mode, recording or editing an environment map, setting a target path, and switching ON/OFF the implement 400. At least some of these manipulations can also be realized by manipulating the operation switches 154. The operational terminal 153 may be configured so as to be detachable from the agricultural machine 300. A user who is remote from the agricultural machine 300 may manipulate the detached operational terminal 153 to control the operation of the agricultural machine 300. Instead of the operational terminal 153, the user may manipulate a computer on which necessary application software is installed, e.g., the terminal apparatus 200, to control the operation of the agricultural machine 300. The operational terminal 153 can also be used as a terminal apparatus to transmit a request signal to the server 100.

First, an example operation of self-traveling by the agricultural machine 300 will be described.

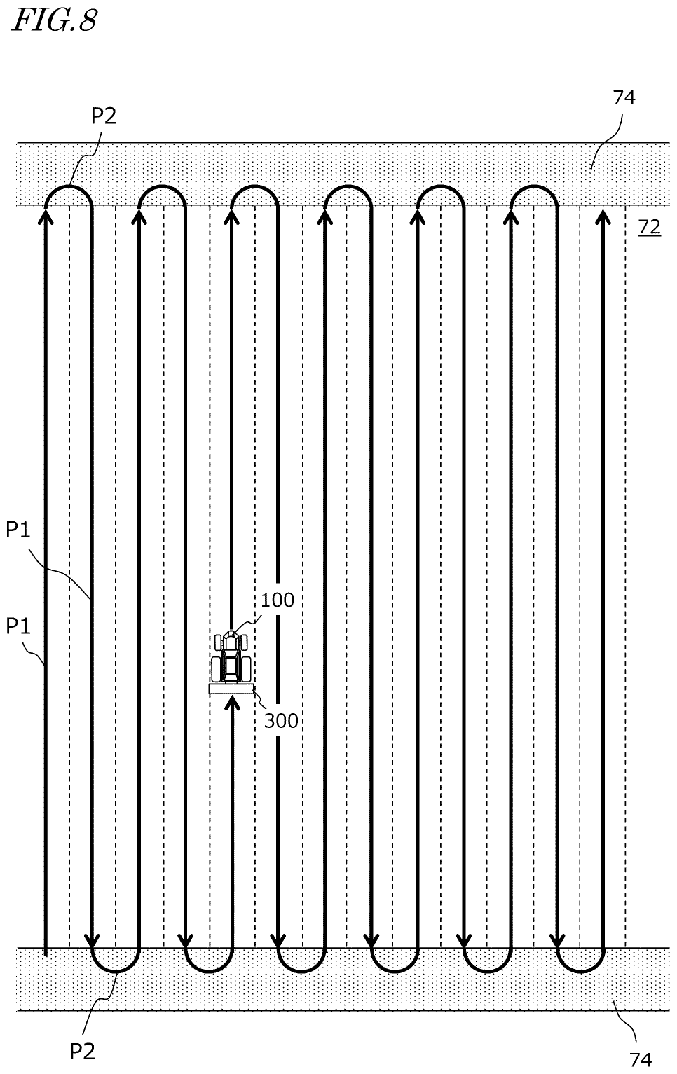

FIG. 8 is a diagram schematically showing an example of an agricultural machine 300 automatically traveling along a target path in a field. In this example, the field includes a work area 72 in which the agricultural machine 300 performs a task by using the implement 400, and headlands 74 that are located near the outer edge of the field. The user may designate which regions on the map of the field would correspond to the work area 72 and the headlands 74 in advance. The target path in this example includes a plurality of parallel main paths P1 and a plurality of turning paths P2 interconnecting the plurality of main paths P1. The main paths P1 are located in the work area 72, whereas the turning paths P2 are located in the headlands 74. Although each main path P1 in FIG. 8 is illustrated as a linear path, each main path P1 may also contain a curved portion(s). Broken lines in FIG. 8 depict the working breadth of the implement 400. The working breadth is previously set and recorded in the storage device 170. The working breadth may be set and recorded as the user manipulates the operational terminal 153. Alternatively, the working breadth may be automatically recognized and recorded when the implement 400 is connected to the agricultural machine 300. The interval between the plurality of main paths P1 may be matched to the working breadth. The target path may be generated based on the user's manipulation, before self-driving is begun. The target path may be generated so as to cover the entire work area 72 in the field, for example. Along the target pathshown in FIG. 8, the agricultural machine 300 automatically travels while reciprocating, from a beginning point of work to an ending point of work. Note that the target path shown in FIG. 8 is only an example, and the target path may be arbitrarily determined.

Next, an example control by the controller 180 during self-driving will be described.

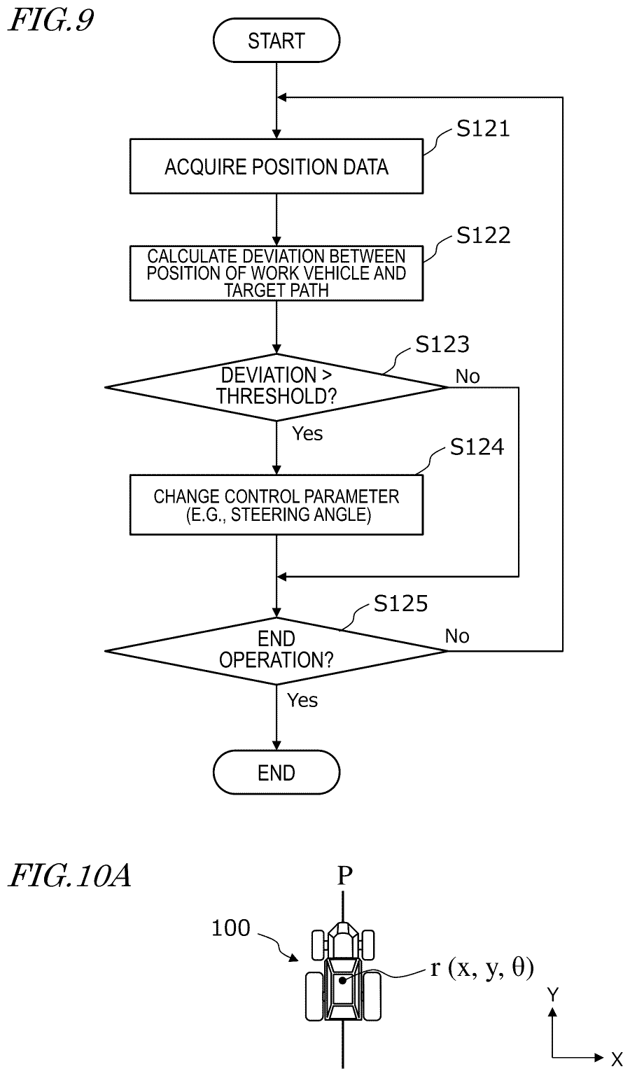

FIG. 9 is a flowchart showing an example operation of steering control to be performed by the controller 180 during self-driving. During travel of the agricultural machine 300, the controller 180 is configured or programmed to perform automatic steering by performing the operation including steps S121 to S125 shown in FIG. 9. The speed will be maintained at a previously-set speed, for example. First, during travel of the agricultural machine 300, the controller 180 acquires data representing the position of the agricultural machine 300 that is generated by the positioning device 130 (step S121). Next, the controller 180 calculates a deviation between the position of the agricultural machine 300 and the target path (step S122). The deviation represents the distance between the position of the agricultural machine 300 and the target path at that moment. The controller 180 determines whether the calculated deviation in position exceeds the previously-set threshold or not (step S123). If the deviation exceeds the threshold, the controller 180 changes a control parameter of the steering device included in the drive device 140 so as to reduce the deviation, thus changing the steering angle (step S124). If the deviation does not exceed the threshold at step S123, the operation of step S124 is omitted. At the following step S125, the controller 180 determines whether a command to end operation has been received or not. The command to end operation may be given when the user has instructed that self-driving be suspended through remote manipulations, or when the agricultural machine 300 has arrived at the destination, for example. If the command to end operation has not been issued, the control returns to step S121 and performs a similar operation based on a newly measured position of the agricultural machine 300. The controller 180 repeats the operation from steps S121 to S125 until a command to end operation is given. The aforementioned operation is executed by the ECUs 182 and 184 in the controller 180.

In the example shown in FIG. 9, the controller 180 controls the drive device 140 based only on a deviation between the position of the agricultural machine 300 as identified by the positioning device 130 and the target path. However, a deviation in terms of directions may further be considered in the control. For example, when a directional deviation exceeds a previously-set threshold, where the directional deviation is an angle difference between the orientation of the agricultural machine 300 as identified by the positioning device 130 and the direction of the target path, the controller 180 may change the control parameter (e.g., steering angle) of the steering device of the drive device 140 in accordance with the deviation.

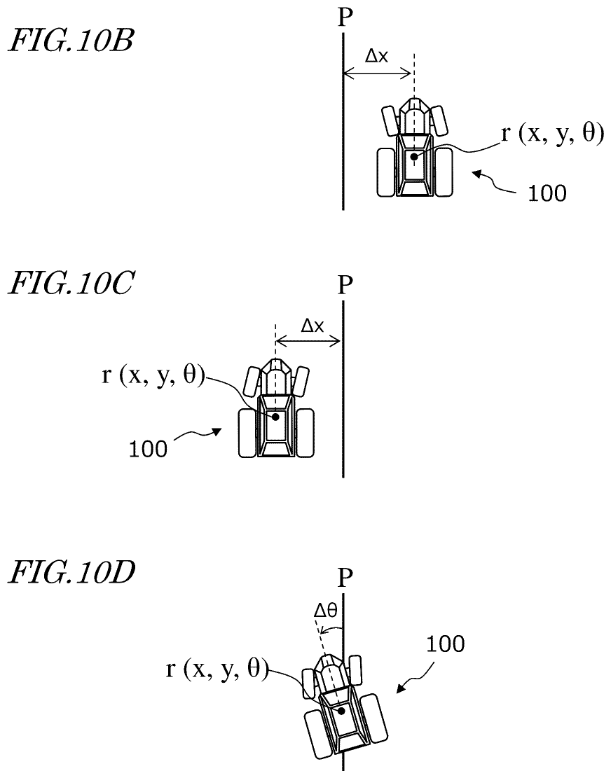

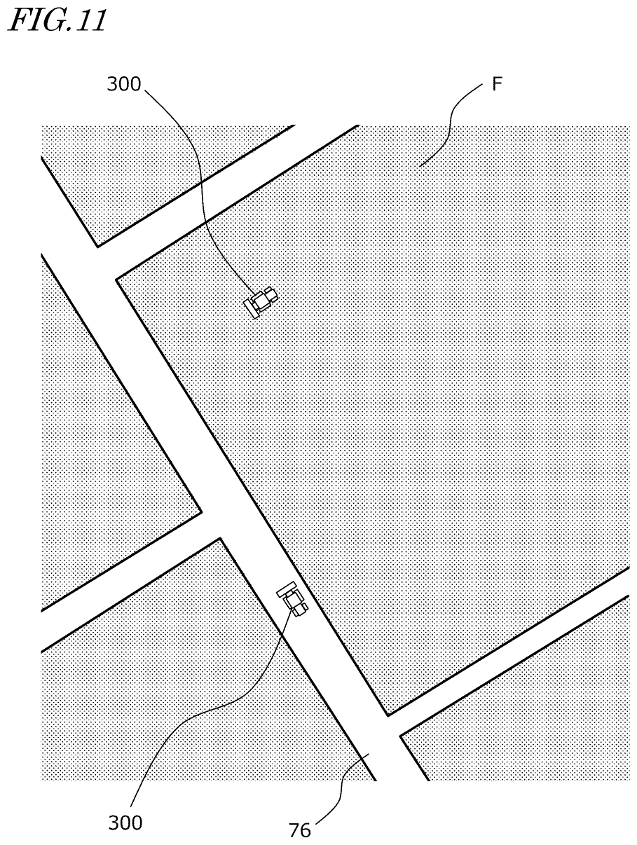

Hereinafter, with reference to FIGS. 10A to 10D, an example of steering control by the controller 180 will be described more specifically.

FIG. 10A is a diagram showing an example of an agricultural machine 300 that travels along a target path P. FIG. 10B is a diagram showing an example of an agricultural machine 300 at a position which is shifted rightward from the target path P. FIG. 10C is a diagram showing an example of an agricultural machine 300 at a position which is shifted leftward from the target path P. FIG. 10D is a diagram showing an example of an agricultural machine 300 which is oriented in an inclined direction with respect to the target path P. In these figures, the pose, i.e., the position and orientation, of the agricultural machine 300 as measured by the positioning device 130 is expressed as r(x,y,θ). Herein, (x,y) are coordinates representing the position of a reference point on the agricultural machine 300, in an XY coordinate system which is a two-dimensional coordinate system being fixed to the globe. In the examples shown in FIGS. 10A to 10D, the reference point on the agricultural machine 300 is at a position on the cabin where a GNSS antenna is disposed, but the reference point may be at any arbitrary position. θ is an angle representing the measured orientation of the agricultural machine 300. Although the target path P is shown parallel to the Y axis in the examples illustrated in these figures, generally speaking, the target path P may not necessarily be parallel to the Y axis.

As shown in FIG. 10A, in the case where the position and orientation of the agricultural machine 300 are not deviated from the target path P, the controller 180 maintains the steering angle and speed of the agricultural machine 300 without changing them.

As shown in FIG. 10B, when the position of the agricultural machine 300 is shifted rightward from the target path P, the controller 180 changes the steering angle so that the traveling direction of the agricultural machine 300 will be inclined leftward, thus bringing the agricultural machine 300 closer to the path P. Herein, not only the steering angle but also the speed may be changed. The magnitude of the steering angle may be adjusted in accordance with the magnitude of a positional deviation Δx, for example.

As shown in FIG. 10C, when the position of the agricultural machine 300 is shifted leftward from the target path P, the controller 180 changes the steering angle so that the traveling direction of the agricultural machine 300 will be inclined rightward, thus bringing the agricultural machine 300 closer to the path P. In this case, too, not only the steering angle but also the speed may be changed. The amount of change of the steering angle may be adjusted in accordance with the magnitude of the positional deviation Δx, for example.

As shown in FIG. 10D, in the case where the position of the agricultural machine 300 is not considerably deviated from the target path P but its orientation is nonetheless different from the direction of the target path P, the controller 180 changes the steering angle so that the directional deviation Δθ will become smaller. In this case, too, not only the steering angle but also the speed may be changed. The magnitude of the steering angle may be adjusted in accordance with the magnitudes of the positional deviation Δx and the directional deviation Δθ, for example. For instance, the amount of change of the steering angle (which is in accordance with the directional deviation Δθ) may be increased as the absolute value of the positional deviation Δx decreases. When the positional deviation Δx has a large absolute value, the steering angle will be changed greatly in order for the agricultural machine 300 to return to the path P, so that the directional deviation Δθ will inevitably have a large absolute value. Conversely, when the positional deviation Δx has a small absolute value, the directional deviation Δθ needs to become closer to zero. Therefore, it may be advantageous to introduce a relatively large weight (i.e., control gain) for the directional deviation Δθ in determining the steering angle.

For the steering control and speed control of the agricultural machine 300, control techniques such as PID control or MPC (Model Predictive Control) may be applied. Applying these control techniques will achieve smoothness of the control of bringing the agricultural machine 300 closer to the target path P.

Note that, when an obstacle is detected by one or more obstacle sensors 136 during travel, the controller 180 halts the agricultural machine 300. Alternatively, when an obstacle is detected, the controller 180 may control the drive device 140 so as to avoid the obstacle. The controller 180 may also detect objects (e.g., other vehicles, pedestrians, etc.) that are located at relatively distant positions from the agricultural machine 300, based on the sensor data which is output from the LiDAR sensor 156. By performing speed control and steering control so as to avoid the detected objects, the controller 180 achieves self-traveling on public roads.

In the present example embodiment, the agricultural machine 300 is able to automatically travel inside the field and outside the field in an unmanned manner. FIG. 11 is a diagram schematically showing an example situation where a plurality of agricultural machines 300 are self-traveling inside a field F and on a road 76 outside the field F. In the storage device 170, an environment map of the inside of the field and the outside of the field including public roads and information of target paths is recorded. The environment map and target paths are generated by the ECU 185 of the controller 180, for example. When the agricultural machine 300 travels on a public road, the agricultural machine 300 travels along a target path while sensing the surroundings by using sensing devices such as the cameras 155 and the LiDAR sensor 156, with the implement 400 raised. During travel, the target path may be changed depending on the situation.

An agricultural machine 300 according to the present example embodiment automatically performs movement between fields and the agricultural task for each field, in accordance with a task schedule that is recorded in a storage device that is mounted on the agricultural machine 300. The task schedule includes information on a plurality of agricultural tasks to be performed over a number of work days. Specifically, the task schedule may be a database that includes information indicating which agricultural task is to be performed by which agricultural machine at which point of time and in which field for each work day. Based on information that is input by the user by using the terminal apparatus 200, the task schedule may be generated by the processor 21 of the server 100. Hereinafter, an example method of generating the task schedule will be described.

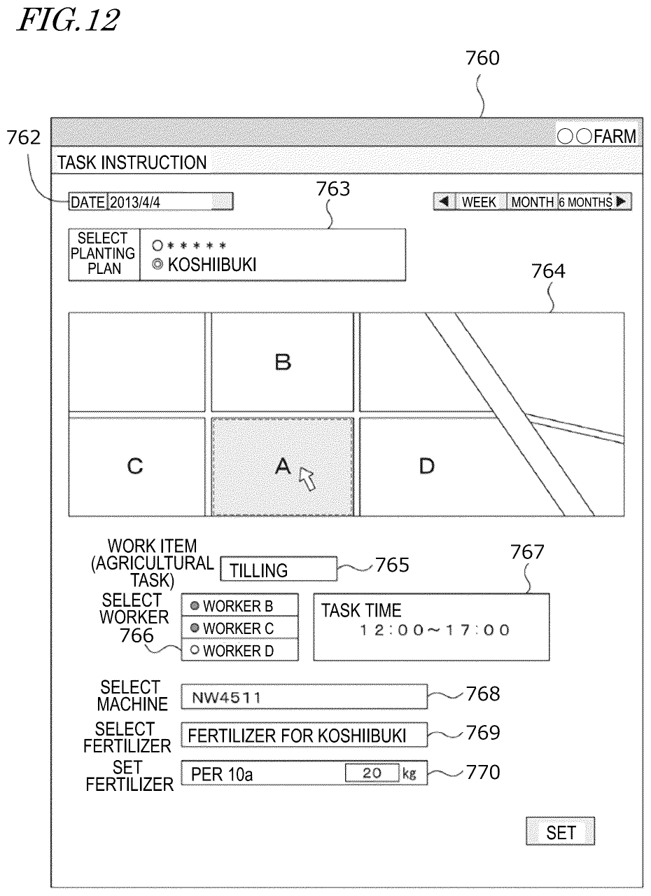

FIG. 12 is a diagram showing an example of a setting screen 760 that is displayed on the display device 220 of the terminal apparatus 200. In accordance with the user's manipulation by using the input device 210, the processor 230 of the terminal apparatus 200 activates an application for schedule generation to cause the setting screen 760 as shown in FIG. 12 on the display device 220. On this setting screen 760, the user is able to input information that is necessary to generate the task schedule.

FIG. 12 shows an example of the setting screen 760 in a case where tilling, including spreading of a fertilizer, is performed as an agricultural task in a field for rice cultivation. Without being limited to what is illustrated in the figure, the setting screen 760 may be modified as appropriate. The setting screen 760 in the example of FIG. 12 includes a date setting section 762, a planting plan selecting section 763, a field selecting section 764, a task selecting section 765, a worker selecting section 766, a time setting section 767, a machine selecting section 768, a fertilizer selecting section 769, and an application amount setting section 770.

In the date setting section 762, a date that has been input with the input device 210 is displayed. The input date is set as a date for performing the agricultural task.

In the planting plan selecting section 763, a list of names of planting plans that was previously created is displayed. The user can select a desired planting plan from this list. The planting plan is previously generated for each kind or cultivar of crop, and recorded in the storage device 30 of the server 100. The planting plan is a plan as to which crop is to be planted in which field. The planting plan is made by an administrator who manages the plurality of fields, etc., prior to planting a crop in a field. The field is a partitioned agricultural field in which crops are to be planted (i.e., grown). In the example of FIG. 4, a planting plan for “Koshiibuki”, which is a cultivar of rice plant, is selected. In this case, the content to be set on the setting screen 760 is associated with the planting plan for “Koshiibuki”.

In the field selecting section 764, fields in the environment map are displayed. The user can select any field from among the displayed fields. In the example of FIG. 12, a portion indicating “field A” is selected. In this case, the selected “field A” is set as the field in which an agricultural task is to be performed.

In the task selecting section 765, a plurality of agricultural tasks that are needed in order to cultivate the selected crop are displayed. The user can select one of the plurality of agricultural tasks. In the example of FIG. 12, “tilling” is selected from among the plurality of agricultural tasks. In this case, the selected “tilling” is set as the agricultural task to be performed.

In the worker selecting section 766, previously-registered workers are displayed. The user can select one or more workers from among the plurality of displayed workers. In the example of FIG. 12, from among the plurality of workers, “worker B, worker C” are selected. In this case, the selected “worker B, worker C” are set as the workers to perform or manage the given agricultural task. In the present example embodiment, because the agricultural machine automatically performs the agricultural task, the worker may not actually perform the agricultural task, but only remotely monitor the agricultural task being performed by the agricultural machine.

In the time setting section 767, a task time that is input via the input device 210 is displayed. The task time is designated by a start time and an end time. The input task time is set as a scheduled time at which the agricultural task is to be performed.

The machine selecting section 768 sets the agricultural machine to be used for the given agricultural task. In the machine selecting section 768, for example, the IDs (identification information) and types or models of the agricultural machines which have been previously registered by the server 100, types or models of usable implements, etc., may be displayed. The user can select a specific machine from among the indicated machines. In the example of FIG. 12, an implement model “NW4511” is selected. In this case, this implement is set as the machine to be used for the given agricultural task.

In the fertilizer selecting section 769, names of a plurality of fertilizers which have been previously registered by the server 100 may be displayed. The user can select a specific fertilizer from among the indicated plurality of fertilizers. The selected fertilizer is set as the fertilizer to be used for the given agricultural task.

In the application amount setting section 770, a numerical value that is input via the input device 210 is displayed. The input numerical value is set as an application amount.

Once a planting plan, a field, an agricultural task, a worker, a task time, a fertilizer, and an application amount are input in the setting screen 760 and “SET” is selected, the communicator 270 of the terminal apparatus 200 transmits the input information to the server 100. The processor 21 of the server 100 stores the received information to the storage device 30. Based on the received information, the processor 21 generates a schedule of agricultural tasks to be performed by each agricultural machine, and stores it to the storage device 30.

Note that the information of agricultural tasks to be managed by the server 100 is not limited to what is described above. For example, an ability to set the kind and application amount of an agrochemical to be used for the field on the setting screen 760 may be provided. An ability to set information on agricultural tasks other than the agricultural task shown in FIG. 12 may be provided.

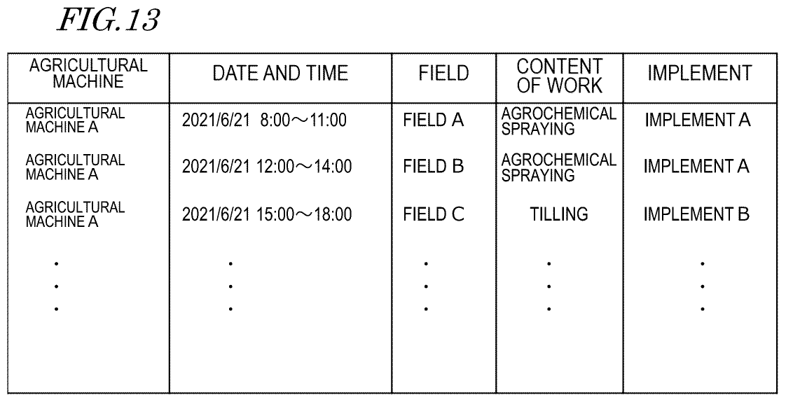

FIG. 13 is a diagram showing an example of a schedule of agricultural tasks to be generated by the server 100. The schedule in this example includes, for each registered agricultural machine, information indicating the date and time at which the agricultural task is to be performed, the field, the contents of work, and the implement used. Other than the information shown in FIG. 13, depending on the contents of work, the schedule may include information on an agrochemical or the application amount of an agrochemical, etc., for example. In accordance with such a schedule, the processor 21 of the server 100 instructs the agricultural machine 300 as to an agricultural task. The schedule is downloaded by the controller of the agricultural machine 300, and may be stored also to the storage device of the agricultural machine 300. In that case, the controller of the agricultural machine 300 may spontaneously begin operation in accordance with the schedule stored in the storage device.

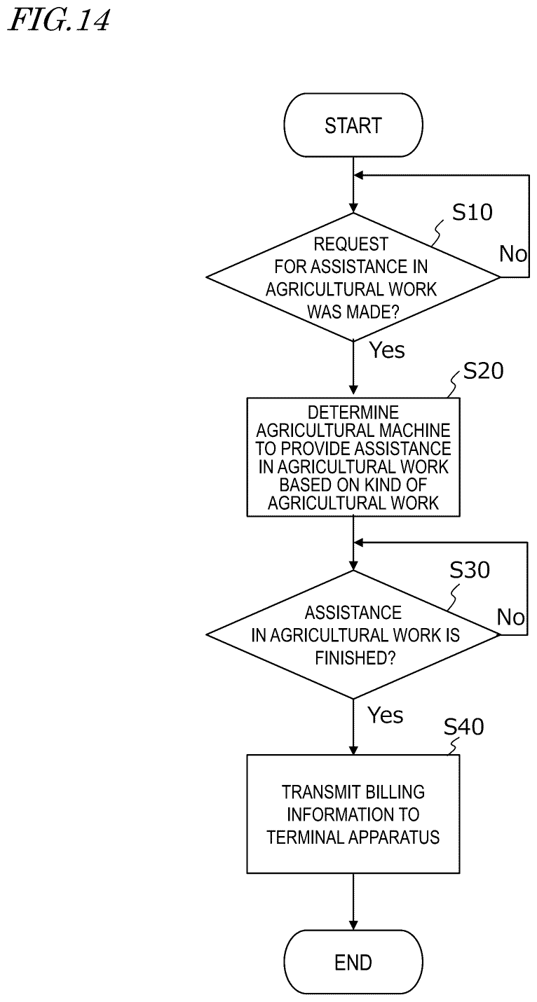

An agricultural assistance method according to the present example embodiment is implemented in the controller 20 of the server 100. FIG. 14 is a flowchart showing a procedure of an example agricultural assistance method according to the present example embodiment. The agricultural assistance method includes: waiting for a request for assistance in agricultural work from the terminal apparatus 200 or the operational terminal 153 (step S10); determining an agricultural machine 300 to provide assistance in the agricultural work in accordance with the kind of agricultural work for the field needing assistance (step S20); waiting for completion of assistance in the agricultural work by the agricultural machine 300 (step S30); and transmitting billing information to the terminal apparatus 200 or the operational terminal 153 (step S40).

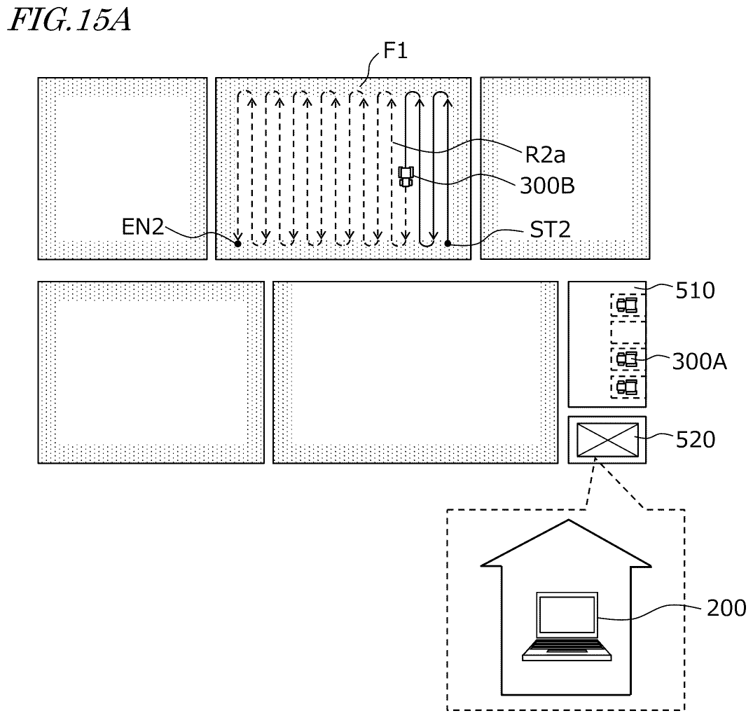

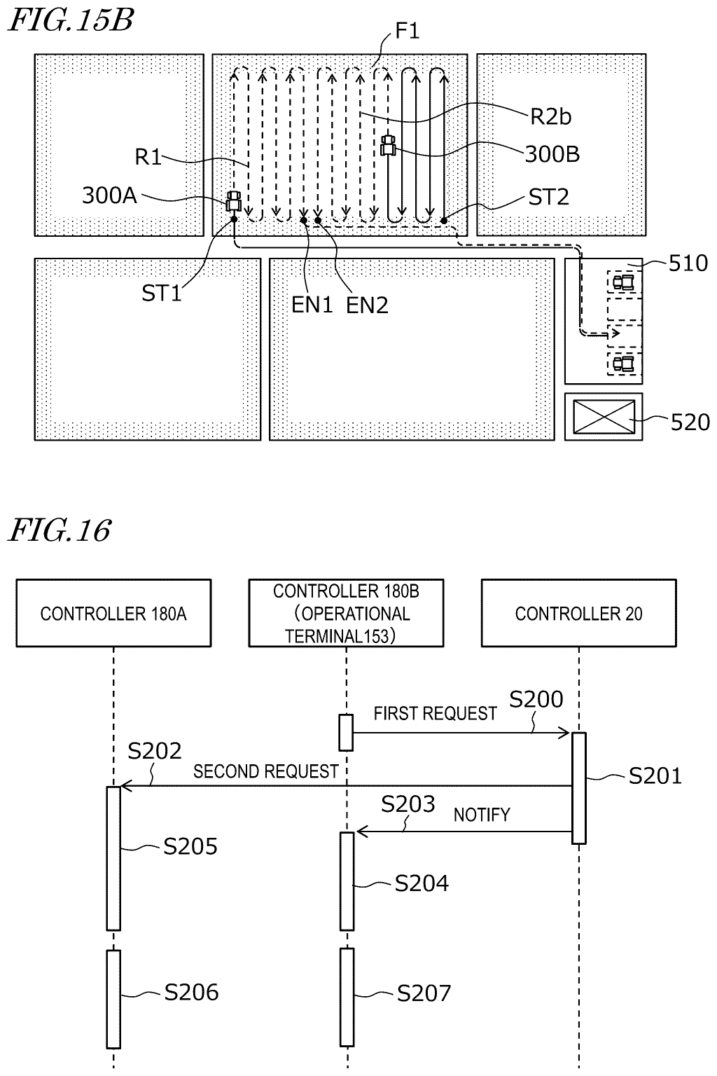

Next, with reference to FIGS. 15A and 15B, an example operation of the server 100 (mainly the controller 20) and the agricultural machine 300 will be described. One or more agricultural machines 300 that are connected to the agricultural assistance system 1000 described below include a first agricultural machine 300A and a second agricultural machine 300B. However, the one or more agricultural machines 300 may include three or more agricultural machines.

The first agricultural machine 300A and the second agricultural machine 300B according to the present example embodiment refer to a task schedule that is transmitted from the server 100, and move from a storage location to a field that is indicated in the task schedule, for example. The first agricultural machine 300A and the second agricultural machine 300B travel via self-driving on a road from the storage location to the field, and also automatically perform work within the field. Note that the first agricultural machine 300A and the second agricultural machine 300B may move via manual driving from the storage location to the field, and perform their work in the field via manual operation of the driver.

Each of FIGS. 15A and 15B is a diagram for describing an overview of assistance in the agricultural work for the field by the agricultural machine 300. In each of FIGS. 15A and 15B, a field map representing a field area that includes a plurality of fields including a field F1, a storage location 510, and a management center 520 is illustrated. FIG. 15A depicts a state where the first agricultural machine 300A is stopped in the storage location 510. FIG. 15B depicts a state where the first agricultural machine 300A is assisting in the work of the second agricultural machine 300B in the field F1. The agricultural machines may be stored in a locked storage location. The storage location may be a barn at the owner's home of the agricultural machines, or a garage of an office of the farm manager, for example.

FIG. 15A shows, with broken-line arrows, a target path R2a for the second agricultural machine 300B to perform agricultural work in the field F1. FIG. 15B shows target paths for the first agricultural machine 300A and the second agricultural machine 300B to work in cooperation in the field F1. More specifically, a target path R1 for the first agricultural machine 300A to perform agricultural work in the field F1 upon receiving a request for assistance and a target path R2b for the second agricultural machine 300B to continue its work in the field F1 are both indicated with broken-line arrows. In FIGS. 15A and 15B, any target path that has already been traveled is indicated by solid lines.

In the case where the first agricultural machine 300A and the second agricultural machine 300B each perform self-driving, a target path for moving to the field and/or a target path for performing agricultural work while moving within the field may be generated manually or automatically before self-driving is begun. Once the target path is determined, the first agricultural machine 300A and the second agricultural machine 300B each automatically travel along the target path. In a storage device that is included in the control system internal to the agricultural machine 300, an environment map including the inside of the field and any public roads outside the field and information of target paths are previously recorded. In the case where the agricultural machine 300 travels along a public road, the agricultural machine 300 may travel along the target path while sensing the surroundings by using sensing devices such as the cameras and the LiDAR sensor, with the implement raised.

In the example shown in FIG. 15A, the second agricultural machine 300B has moved from the storage location 510 to the field F1, and is performing agricultural work. The first agricultural machine 300A and one or more other agricultural machines are stopped in the storage location 510, ready to provide assistance in agricultural work for the field. The controller 180 of the first agricultural machine 300A controls operation of the first agricultural machine 300A. The controller 180 of the second agricultural machine 300B controls operation of the second agricultural machine 300B. Hereinafter, the controller 180 of the first agricultural machine 300A and the controller 180 of the second agricultural machine 300B will be respectively referred to as the “controller 180A” and the “controller 180B” for distinction. Moreover, a request signal that is transmitted from the operational terminal 153 or the terminal apparatus 200 to the controller 20 and a request signal that is transmitted from the controller 20 to the controller 180A will be respectively referred to as a “first request signal” and a “second request signal” for distinction.

FIG. 16 is a diagram showing example operations of the controller 180A of the first agricultural machine 300A, the controller 180B of the second agricultural machine 300B,and the controller 20 of the server 100. However, the respective operations according to the example embodiments of the present disclosure are not limited to these.

### Step S200

First, a first request signal is transmitted from the operational terminal 153 of the second agricultural machine 300B to the controller 20. The first request signal includes positional information of the second agricultural machine 300B, which has requested assistance in agricultural work.

### Step S201

By referring to positional information of the second agricultural machine 300B and an environment map that is stored in the storage device 30, the controller 20 identifies the field F1 in which the second agricultural machine 300B is located. Moreover, by referring to the task schedule, the controller 20 determines an agricultural machine to provide work assistance from among one or more agricultural machines 300 which are stopped in the storage location 510, for example.

For example, in response to receiving a first request signal from the operational terminal 153, by referring to the environment map, the controller 20 identifies the position of the field F1 from the positional information of the second agricultural machine 300B, on which the operational terminal 153 having transmitted the first request signal is mounted. Moreover, by referring to the task schedule, the controller 20 determines an agricultural machine that is not performing any agricultural work when receiving the first request signal, e.g., the first agricultural machine 300A stopped in the storage location 510, as an agricultural machine to provide work assistance. From among a plurality of agricultural machines 300 stopped in the storage location 510, for example, the controller 20 can determine an agricultural machine that is suited for the work for the field F1 or an agricultural machine having attached thereto an implement that is suited to the work for the field F1, based on information included in the task schedule that is needed for assistance concerning the type of the agricultural machine or the item of agricultural work.

### Step S202

In response to the first request signal, the controller 20 transmits to the controller 180A a second request signal including a command for the first agricultural machine 300A to move to the field F1, in which the second agricultural machine 300B is located. For example, the controller 20 transmits a second request signal including the positional information of the field F1to the controller 180A of the first agricultural machine 300A being stopped in the storage location 510.

### Step S203

Upon determining an agricultural machine to provide work assistance, the controller 20 notifies the second agricultural machine 300B that an agricultural machine to provide work assistance has been determined.

### Step S204

The second agricultural machine 300B is performing agricultural work while self-traveling within the field F1 along the target path R2a, until the target path R2a is changed. Upon receiving the notification from the controller 20, the controller 180B changes the target path needed for the self-driving of the second agricultural machine 300B in the field F1. Upon receiving the notification from the controller 20, the controller 180B changes the target path R2a in the field F1 to the target path R2b.

As shown in FIG. 15A, before the first request signal is transmitted from the operational terminal 153 of the second agricultural machine 300B to the controller 20, the target path R2a of the second agricultural machine 300B is set for the field F1. The target path R2a includes a start point ST2 of beginning work, an end point EN2 of ending work, and traveling directions as indicated by arrows in the figure. On the other hand, as shown in FIG. 15B, after receiving the notification from the controller 20, the controller 180B changes the target path R2a to the target path R2b. The controller 180B sets a new end point EN2 by moving the initially-conceived end point EN2 included in the target path R2a to an arbitrary position on the target path R2a that is closer to the start point ST2, thereby generating the target path R2b. Stated otherwise, the controller 180B generates the target path R2b by shortening the initially-conceived length (i.e., a length from the start point ST2 to the end point EN2) of the target path R2a.

### Step S205

Upon receiving the second request signal, the controller 180A begins a control to cause the first agricultural machine 300A to move to the field F1. Upon receiving the second request signal from the controller 20, the controller 180A generates a target path R1 for the first agricultural machine 300A to perform agricultural work in the field F1 needing assistance.

The controller 180A may acquire the target path R2a of the second agricultural machine 300B via the server 100, and generate the target path R1 by utilizing the target path R2a. The controller 180A may generate the target path R1 by setting the end point EN2 of the target path R2a as the start point ST1 of the target path R1 and setting an arbitrary point on the target path R2a as the end point EN1 of the target path R1. The controller 180A also generates a target path for moving between the storage location 510 and the field F1.

### Step S206

The controller 180A causes the first agricultural machine 300A to perform self-traveling along the target path R1. As the first agricultural machine 300A arrives at the start point ST1, the controller 180A activates the implement to cause the first agricultural machine 300A to begin work from the start point ST1. By controlling the operation of the steering device 106 and the like, the controller 180A causes the first agricultural machine 300A to work while automatically traveling in traveling directions along the target path R1.

### Step S207

The controller 180B causes the second agricultural machine 300B to perform self-traveling along the target path R2b. By controlling the operation of the steering device 106 and the like, the controller 180B causes the second agricultural machine 300B to work while automatically traveling in traveling directions along the target path R2b.

Thus, once generation of the target paths R2b and R1 in the field F1 is completed, the second agricultural machine 300B performs work while self-driving along the target path R2b, and the first agricultural machine 300A moves from the storage location 510 to the field F1 and thereafter performs work while self-driving along the target path R1.

In the above-described example operation, it is via the server 100 that the controller 180A receives the second request signal transmitted from the controller 20 in response to the first request signal transmitted from the operational terminal 153. However, the controller 180A may directly receive the first request signal from the operational terminal 153, rather than via the server 100. In this case, upon receiving the first request signal from the operational terminal 153, by referring to the environment map, the controller 180A may identify the position of the field F1 from positional information of the second agricultural machine 300B, on which the operational terminal 153 having transmitted the first request signal is mounted. Upon receiving the first request signal, the controller 180A begins the control to cause the first agricultural machine 300A to move to the field F1. Moreover, as mentioned above, the controller 180B changes the target path needed for the self-driving of the second agricultural machine 300B in the field F1.

In the above-described example operation, each of the controller 180A and the controller 180B generates a target path by itself after receiving the second request signal and the notification from the controller 20. However, the present disclosure is not limited thereto. For example, after receiving the first request signal from the controller 180, the controller 20 may generate target paths R1 and R2b for the first agricultural machine 300A and the second agricultural machine 300B, and transmit the generated target paths R1 and R2b to the controller 180A and the controller 180B, respectively. Moreover, the first request signal is illustrated as being transmitted from the operational terminal 153 mounted in the agricultural machine 300. Alternatively, the first request signal may be transmitted from the terminal apparatus 200 which is used by an administrator or the like.

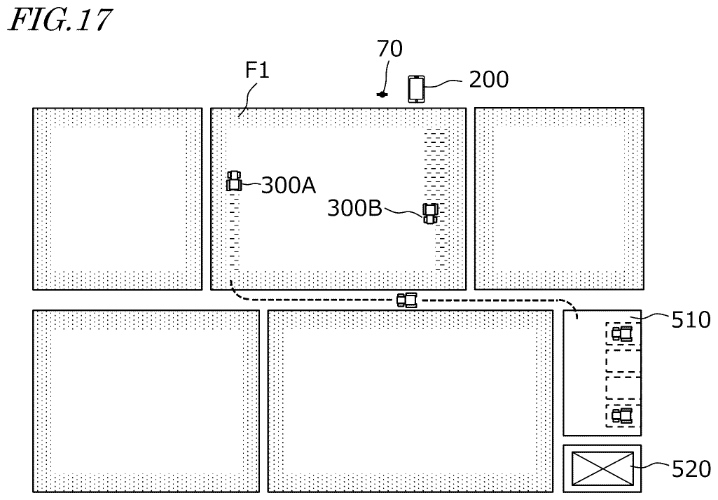

With reference to FIG. 17 to FIG. 20, an example of transmitting the first request signal from the terminal apparatus 200 will be described.

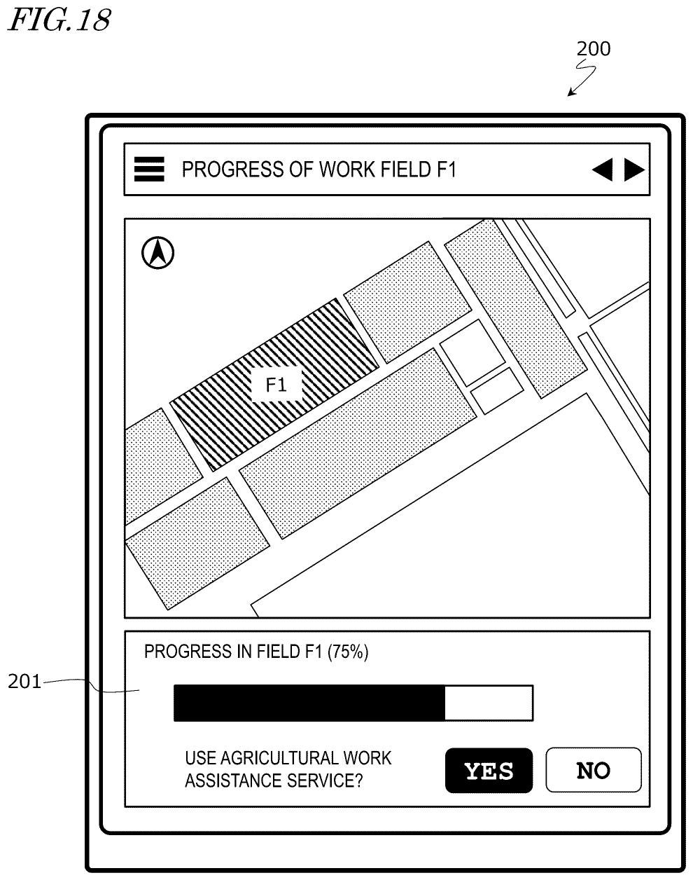

FIG. 17 is a diagram illustrating a state where an administrator 70 who is in the neighborhood of the field F1 is using the terminal apparatus 200 to manage the progress of work in the field F1 that is performed by the second agricultural machine 300B. FIG. 18 is a diagram showing an example indication of progress of work to be displayed on a display of the terminal apparatus 200.

By using the terminal apparatus 200, the administrator 70 may monitor the second agricultural machine 300B from within the field F1 or from the neighborhood of the field F1. When managing the progress of work of the second agricultural machine 300B, the administrator 70 can easily confirm whether any delay in work has occurred or not from the progress of work indication displayed on the terminal apparatus 200, for example.

The progress of work indication 201 in the example shown in FIG. 18 includes a bar chart that shows how the actual progress goes as compared to the initially-conceived task schedule in percentage (%). The indication 201 may include a choice indication section in which the user is allowed to choose to use the agricultural work assistance service, for example. In the illustrated example, if the administrator 70 chooses “YES”, a first request signal is transmitted from the terminal apparatus 200 to the controller 20. In response to the first request signal from the terminal apparatus 200, the controller 20 transmits a second request signal indicating a request for assistance in the work of the second agricultural machine 300B to the first agricultural machine 300A being stopped in the storage location 510,for example, and commands the first agricultural machine 300A to move to the field F1, in which the second agricultural machine 300B is located. In accordance with this command, the controller 180A may cause the first agricultural machine 300A to move to the field F1.

After the agricultural work for the field F1 is finished, as positional information of a destination, the controller 20 transmits to the first agricultural machine 300A the positional information of the original storage location 510, and commands the first agricultural machine 300A to return to the storage location 510. In accordance with this command, the controller 180A may cause the first agricultural machine 300A to move to the storage location 510.

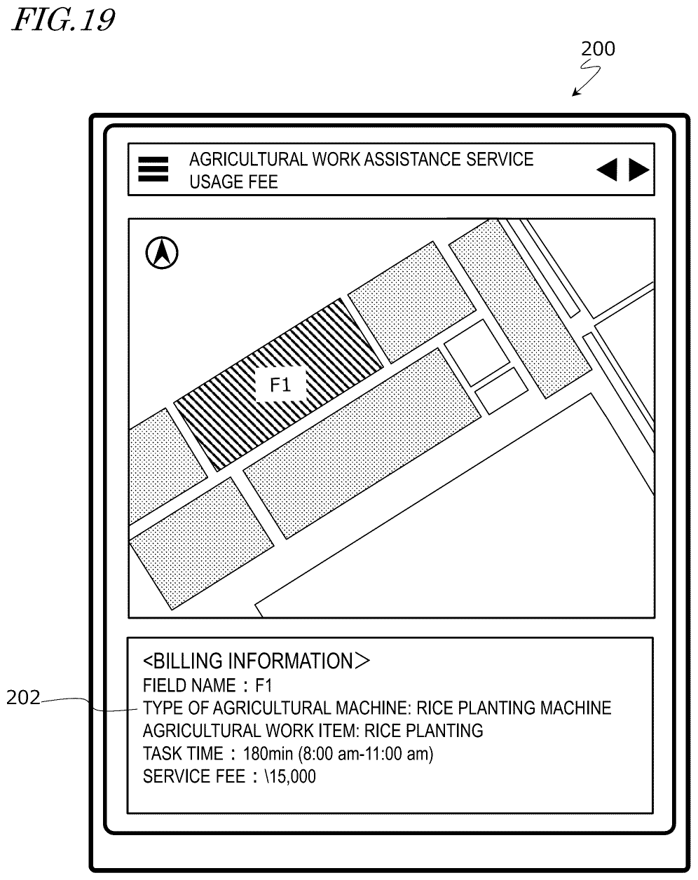

FIG. 19 is a diagram showing an example indication of a statement of usage to be displayed on the terminal apparatus 200 after the agricultural work assistance service is used. The controller 20 may generate a work log including at least one piece of information among contents of work, task time, and type of agricultural machine for the work assistance by the agricultural machine 300, and record it to the storage device 30. For example, in response to a request from administrator M1, the controller 20 may generate a work log including information among contents of work, task time, and type of agricultural machine for the agricultural work which was performed in the field F1 by the first agricultural machine 300A being possessed by administrator M2, who is distinct from administrator M1, and transmit data of the generated work log to the terminal apparatus 200 of administrator M1.

The controller 20 may calculate a rent for the agricultural machine 300 based on the work log, and transmit billing information that includes the rent to the terminal apparatus 200 of administrator M1. By displaying the billing information 202 illustrated in FIG. 18 on the terminal apparatus 200, it is possible to urge an administrator M1 to pay a usage fee for the agricultural work assistance service. The agricultural work assistance service may be a volume-based service in which the usage fee is calculated according to the task time and the type of agricultural machine, or a flat-rate service of subscription type. For example, by paying a fixed usage fee, the user is able to use the agricultural work assistance service for a certain period of time. As a result, an agricultural machine sharing service of subscription type may be realized, for example.

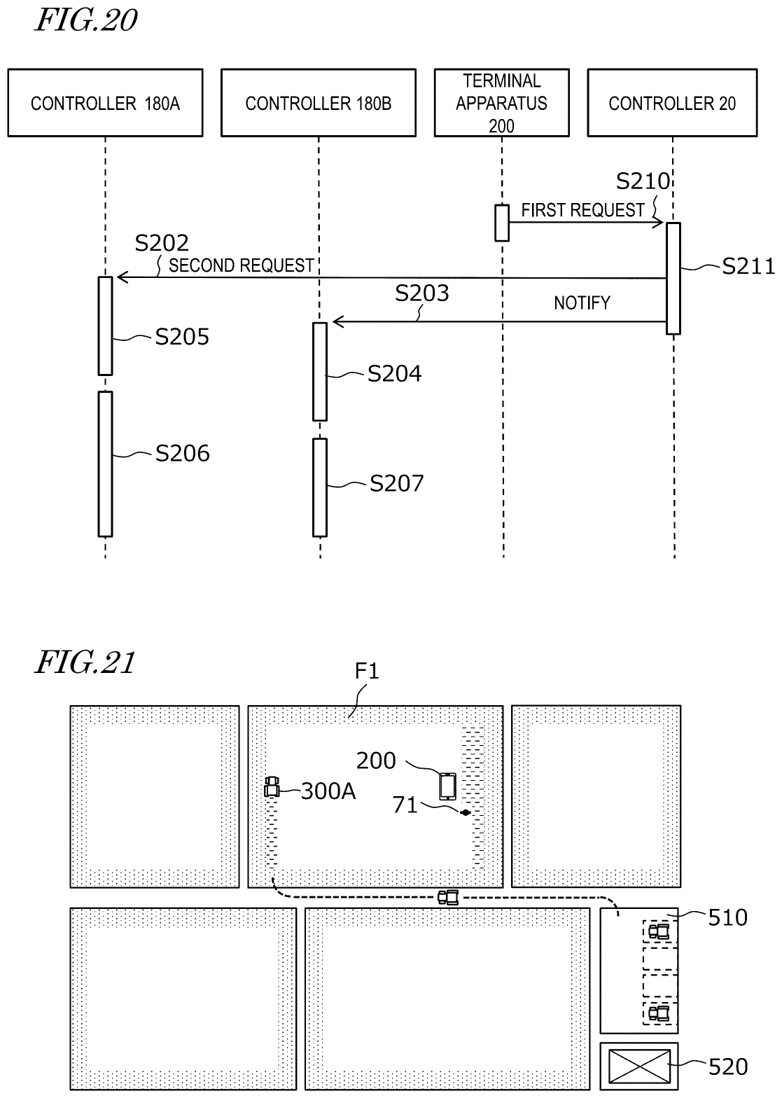

FIG. 20 is a diagram showing example operations of the controller 180A of the first agricultural machine 300A, the controller 180B of the second agricultural machine 300B, the terminal apparatus 200, and the controller 20 of the server 100 where, in the case where assistance in the work of an agricultural machine is requested from the terminal apparatus 200 being used by the user. However, the respective operations according to the example embodiments of the present disclosure are not limited to these. In FIG. 20, any process that is similar to a process shown in FIG. 16 is denoted by the same reference numeral, and the description thereof is omitted.

As shown in FIG. 20, a first request signal is transmitted from the terminal apparatus 200 to the controller 20 (step S210). The first request signal includes positional information of the field F1 needing assistance, in which a user using the terminal apparatus 200 is located. By referring to the positional information of the field F1 needing assistance and an environment map that is stored in the storage device 30, the controller 20 identifies the field F1 where the user is located. Moreover, by referring to the task schedule, the controller 20 determines the first agricultural machine 300A stopped in the storage location 510, for example, as an agricultural machine to provide work assistance (step S211).

FIG. 21 is a diagram illustrating a state where an agricultural worker 71 is performing manual work in the field F1 while carrying the terminal apparatus 200. From the progress of work indication that is displayed by the terminal apparatus 200, for example, the agricultural worker 71 can grasp the progress of work that is being performed by himself or herself. If the agricultural worker 71 desires assistance in the agricultural work, the agricultural worker 71 may use the terminal apparatus 200 to transmit to the controller 20 a first request signal requesting assistance in the agricultural work for the field F1. In response to the first request signal from the terminal apparatus 200, the controller 20 transmits a second request signal indicating a request for assistance in the manual work which is being performed by the agricultural worker 71 in the field F1, to the first agricultural machine 300A stopped in the storage location 510, for example, and commands it to move to the field F1 in which the agricultural worker 71 is working, for example. After the agricultural work in the field F1 is finished, the controller 20 may transmit to the controller 180 a command indicating that the original storage location 510 is the destination. In accordance with this command, the controller 180A may cause the first agricultural machine 300A to move to the original storage location 510.

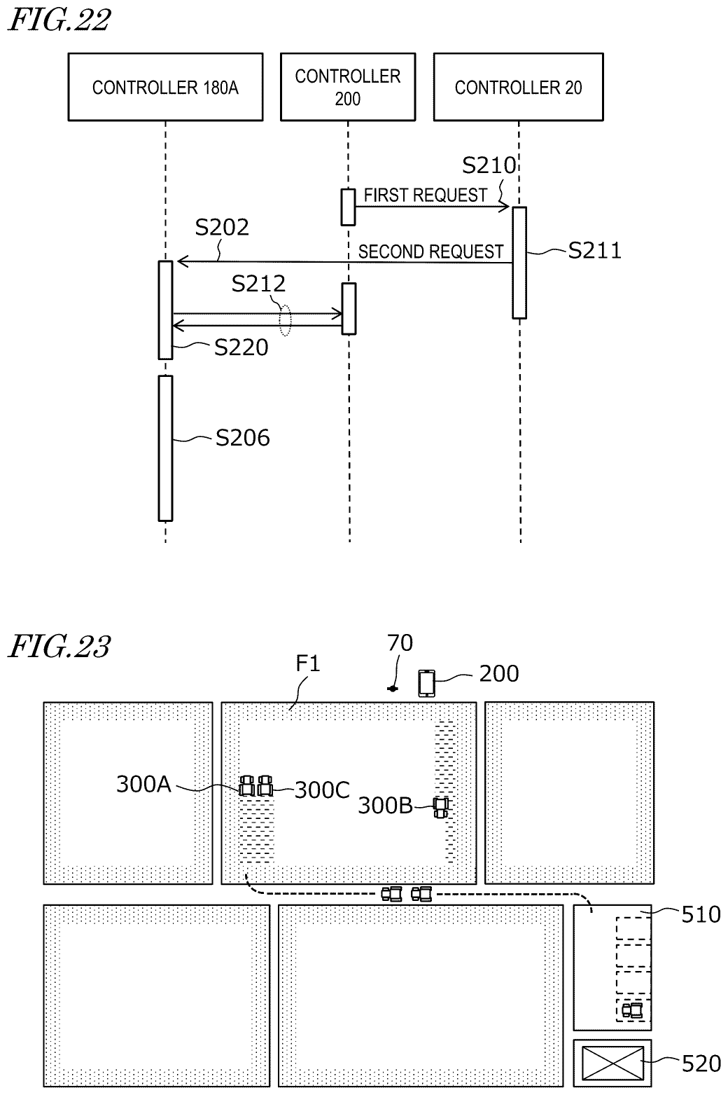

FIG. 22 is a diagram showing example operations of the controller 180A of the first agricultural machine 300A, the terminal apparatus 200, and the controller 20 of the server 100 in a case where the worker requests assistance in work by using the terminal apparatus 200. However, the respective operations according to the example embodiments of the present disclosure are not limited to these. In FIG. 22, any process that is similar to a process shown in FIG. 20 is denoted by the same reference numeral, and the description thereof is omitted.

As shown in FIG. 22, through steps S210 and S211, upon identifying the first agricultural machine 300A the controller 20 transmits a second request signal to the controller 180A. The second request signal in this case includes information indicating that there is no agricultural machine that is performing work in the field F1 needing assistance, or information indicating that the request represents a request for assistance in the worker's manual work, for example.

As shown in FIG. 22, the controller 180A may communicate with the terminal apparatus 200 (step S212) to acquire from the terminal apparatus 200 an unworked range where work is not being performed in the field F1, and generate a target path R1 in the unworked range (step S220).

FIG. 23 is a diagram illustrating a state in which the administrator 70 being in the neighborhood of the field F1 is using the terminal apparatus 200 to manage the progress of work in the field F1 performed by the second agricultural machine 300B, and in which the administrator 70 is receiving assistance in the agricultural work by one or more agricultural machines 300.

In response to receiving a first request signal from the terminal apparatus 200, the controller 20 in the present example embodiment transmits a second request signal requesting the first agricultural machine 300A and the third agricultural machine 300C, which are able to move to the field F1, to assist in the work for the field F1. By performing agricultural work of the same content, the agricultural machines 300A to 300C can accelerate the work in the field F1.

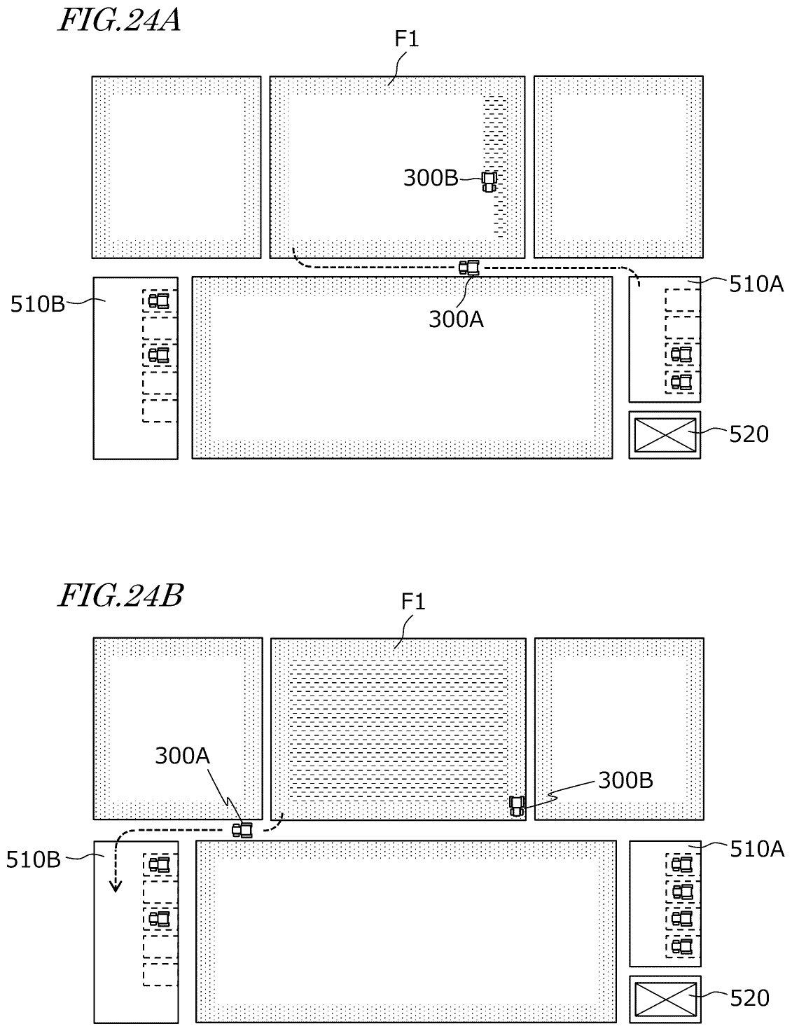

Each of FIGS. 24A and 24B is a diagram for describing an example where, after agricultural work for the field F1 is finished, the first agricultural machine 300A is moved to a storage location that is distinct from the storage location in which the first agricultural machine 300A was stopped. In each of FIGS. 24A and 24B, a field map representing a field area that includes a plurality of fields including the field F1, a first storage location 510A, a second storage location 510B, and a management center 520 is illustrated. The first and second storage locations 510A and 510B in the present example embodiment may be possessed by respectively different administrators. For example, in a case where administrator M1 makes a request for assistance in agricultural work, administrator M2 may possess the first storage location 510A, and administrator M3 may possess the second storage location 510B.

In response to receiving a first request signal from the terminal apparatus 200, the controller 20 transmits a second request signal requesting assistance in the field F1 to the first agricultural machine 300A being stopped in the first storage location 510A. As illustrated in FIG. 24B, when the first agricultural machine 300 finishes work in the field F1, if the original storage location 510A is full of other agricultural machines 300 such that there is no storing space left, the controller 20 may transmit to the controller 180A a command indicating the second storage location 510B, in which some storing space remains, as a destination for the first agricultural machine 300A.

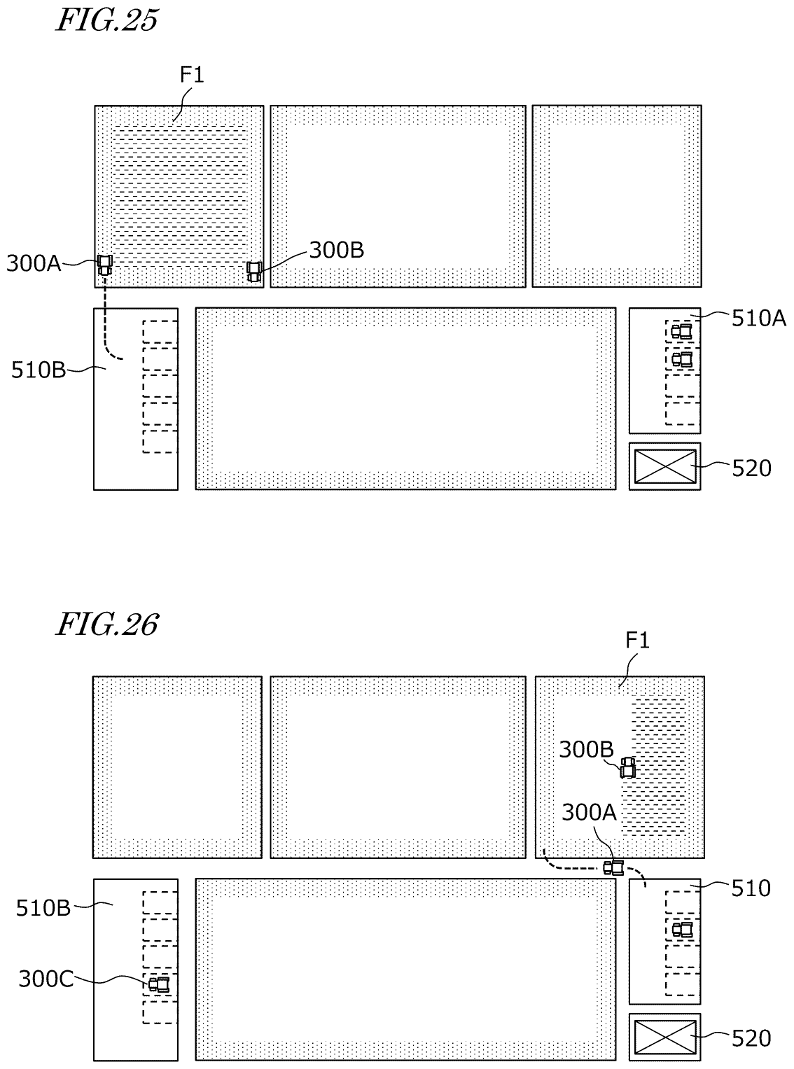

FIG. 25 is a diagram showing another example where, after agricultural work for the field F1 is finished, the first agricultural machine 300A is moved to a storage location that is distinct from the storage location in which the first agricultural machine 300A was stopped.

In response to receiving a first request signal from the terminal apparatus 200, the controller 20 may transmit to the controller 180A a second request signal to cause the first agricultural machine 300A being stopped in the first storage location 510A to move to the field F1. After the agricultural work in the field F1 is finished, the first agricultural machine 300A may move to the second storage location 510B. In this example, the distance from the field F1 to the second storage location 510B is shorter than the distance from the field F1 to the first storage location 510A. When the first agricultural machine 300 has finished work in the field F1, if there is any storing space left in the second storage location 510B, the controller 20 may cause the first agricultural machine 300 to move to the second storage location 510B. Under such control, the time needed for the agricultural machine 300 to return to the storage location can be reduced.

For each field, the storage device 30 of the server 100 may previously store data of plot polygons having spatial information representing its position on the globe (i.e., geographic coordinates) and its shape as well as attribute information. “Plot polygons” are plot information of a field that is generated from plot to plot based on aerial photographs or satellite images, etc., so as to follow the shape of the field. “Geographic coordinates” mean a position in a geographic coordinate system that expresses any position on the globe in terms of latitude and longitude, or in a projected coordinate system obtained by projecting three-dimensional coordinates on the globe onto a two-dimensional plane and expressing any position on the globe in terms of XY coordinates. For example, based on plot polygons, the controller 20 may determine the coordinates in the geographic coordinate system of each vertex defining the shape of a field region or a storage location, and calculate the barycentric coordinates of the shape of a field region or a storage location based on the determined coordinates. The controller 20 can calculate a distance from a field to another field, or a distance from a field to a storage location, as a Euclidean distance or a Manhattan distance between two barycentric coordinate points, for example.

The controller 20 according to the present example embodiment may transmit a second request signal, as an instruction of a movement to the field F1, to the first agricultural machine 300A or the third agricultural machine 300C as was determined based on the relative positioning, at the time when a first request signal is received, between: the place where the first agricultural machine 300A is located; the place where the third agricultural machine 300C is located; and the field F1.

FIG. 26 is a diagram for describing an example where, in a case where the first storage location 510A is closer to the field F1 than is the second storage location 510B, the agricultural machine 300 at the first storage location 510A is moved to the field F1.

In this example, one or more agricultural machines 300 are stopped in each of the first storage location 510A and the second storage location 510B. The distance from the field F1 to the second storage location 510B is longer than the distance from the field F1 to the first storage location 510A. In this case, when the first agricultural machine 300A is stopped in the first storage location 510A and the third agricultural machine 300C is stopped in the second storage location 510B, in response to receiving a first request signal from the terminal apparatus 200, the controller 20 may determine the first agricultural machine 300A as an agricultural machine to be moved to the field F1 needing assistance.

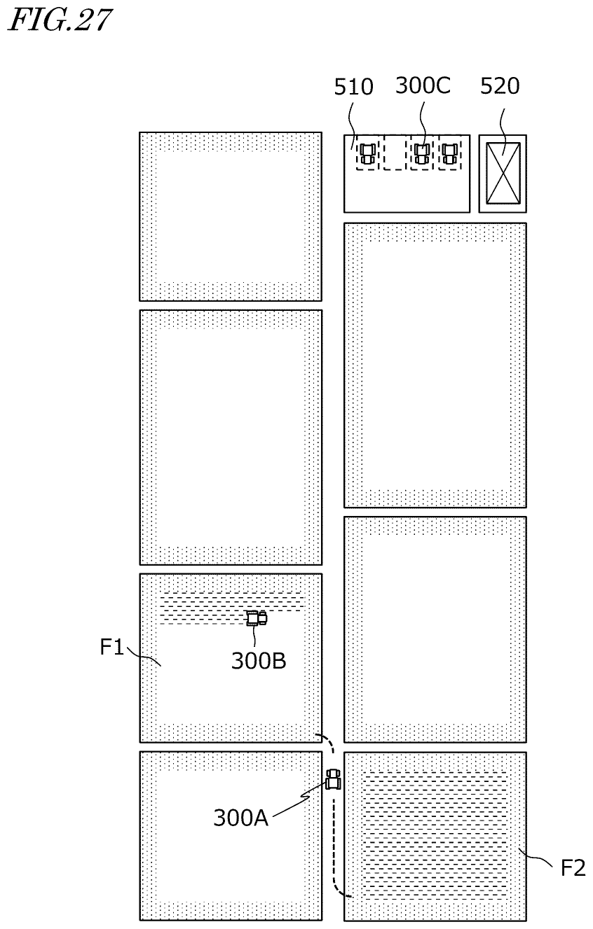

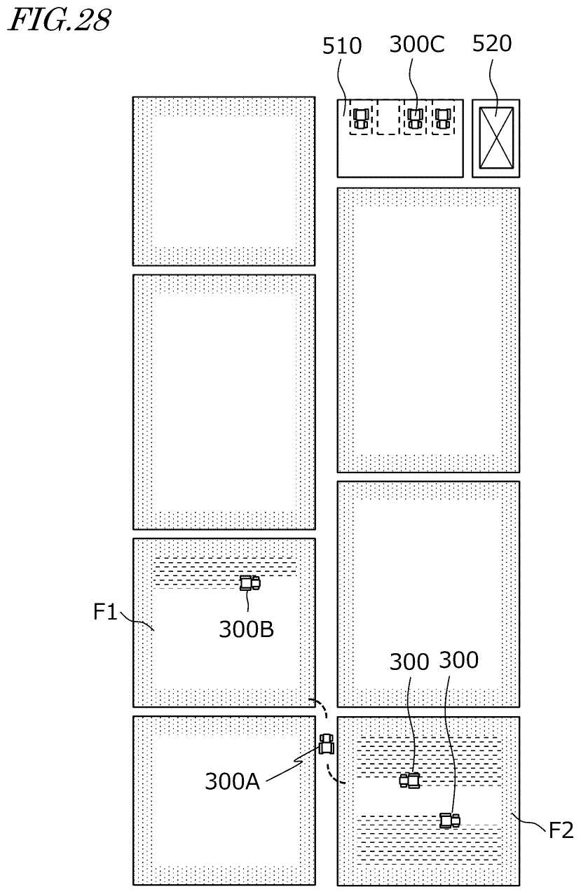

Each of FIG. 27 and FIG. 28 is a diagram for describing an example where, in a case where another field F2 is closer to the field F1 than is the storage location 510, an agricultural machine 300 performing agricultural work in the field F2 is moved to the field F1.

In this example, the distance from the field F1 to the field F2 is shorter than the distance from the field F1 to the storage location 510. In this case, when the third agricultural machine 300C is stopped in the storage location 510 and the first agricultural machine 300A is performing agricultural work in the field F2, in response to receiving a first request signal from the terminal apparatus 200, the controller 20 may determine the first agricultural machine 300A as an agricultural machine to be moved to the field F1 needing assistance.

After the first agricultural machine 300A has finished work in the field F1, the controller 20 commands the controller 180A to move the first agricultural machine 300A from the field F2 to the field F1. In accordance with this command, the controller 180A causes the first agricultural machine 300A to move to the field F1. The control in this example is effective in the case where, as compared to causing an agricultural machine that is stopped in a storage location to move to the field, it is a quicker way of beginning assistance in the agricultural work to cause an agricultural machine that is about to finish work in another field to move to the field after finishing work; or where it is a quicker way of beginning assistance in the agricultural work to cause an agricultural machine that has finished work earlier than is scheduled to move to the field, etc., for example.

As is illustrated in FIG. 28, if one or more agricultural machines 300 are performing work in the field F1 other than the first agricultural machine 300A, the controller 20 may not need to wait for the work in the field F1 to be finished in causing the first agricultural machine 300A to move to the field F1. The controller 20 may allow the agricultural machine(s) 300 other than the first agricultural machine 300A to continue work in the field F1.

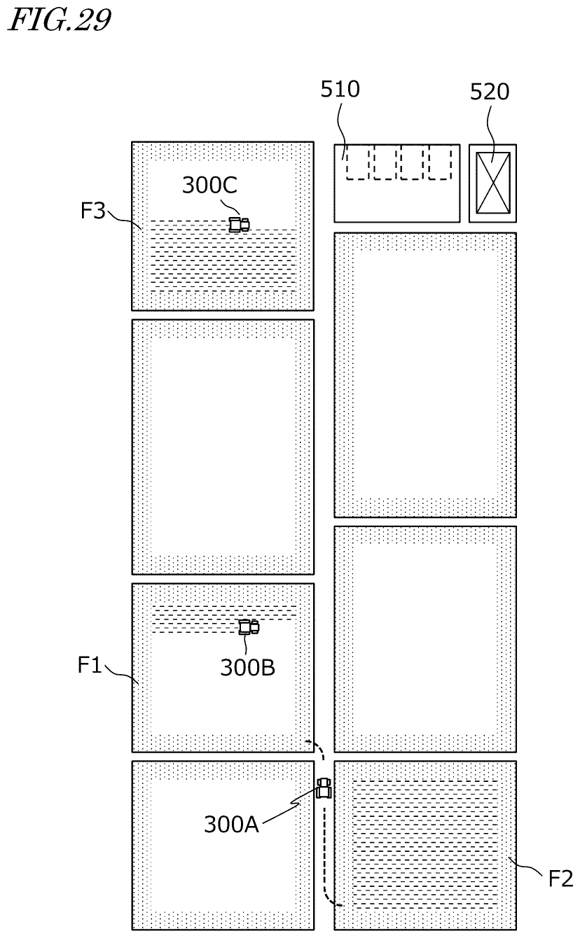

FIG. 29 is a diagram for describing an example where, in a case where the field F2 is closer to the field F1 than is a field F3, an agricultural machine 300 performing agricultural work in the field F2 is moved to the field F1.

In this example, there is no agricultural machine 300 that is stopped in the storage location 510. The distance from the field F3 to the field F1 is longer than the distance from the field F1 to the field F2. In this case, when the first agricultural machine 300A is performing agricultural work in the field F2 and the third agricultural machine 300C is performing agricultural work in the field F3, in response to receiving a first request signal from the terminal apparatus 200, the controller 20 commands the controller 180A to move the first agricultural machine 300A from the field F2 to the field F1. In accordance with this command, the controller 180 causes the first agricultural machine 300A to move to the field F1. Preferably, the controller 20 designates the field F1 to be the destination of the first agricultural machine 300A after the first agricultural machine 300A has finished work in the field F2. The control in this example is effective in the case where all agricultural machines that were stopped in a storage location have gone out in response to requests for assistance in agricultural work.

In the aforementioned examples, when a request for assistance is made from the terminal apparatus or the operational terminal, the controller in the agricultural machine performs self-driving control to cause one or more agricultural machines to move to a field. Alternatively, however, the controller of the server may perform self-driving control to cause one or more agricultural machines to move to a field when a request for assistance is made from the terminal apparatus or the operational terminal. In this case, through remote manipulations at the server, self-driving of the agricultural machine may be achieved.

A system that provides various functions according to example embodiments can be mounted on an agricultural machine lacking such functions as an add-on. Such a system may be manufactured and sold independently from the agricultural machine. A computer program for use in such a system may also be manufactured and sold independently from the agricultural machine. The computer program may be provided in a form stored in a non-transitory computer-readable, non-transitory storage medium, for example. The computer program may also be provided through downloading via telecommunication lines (e.g., the Internet).

A system that provides various functions according to example embodiments can be mounted on an agricultural machine lacking such functions as an add-on. Such a system may be manufactured and sold independently from the agricultural machine. A computer program for use in such a system may also be manufactured and sold independently from the agricultural machine. The computer program may be provided in a form stored in a computer-readable, non-transitory storage medium, for example. The computer program may also be provided through downloading via telecommunication lines (e.g., the Internet).

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An agricultural assistance system to assist with agricultural work with one or more agricultural machines, the agricultural assistance system comprising:
a controller configured or programmed to control an operation of the one or more agricultural machines; wherein
in response to receiving from a terminal apparatus a signal requesting assistance in agricultural work for a field, the controller is configured or programmed to cause the one or more agricultural machines to move to the field to assist in the agricultural work for the field.

2. The agricultural assistance system of claim 1, wherein the controller is configured or programmed to:
control an operation of a first agricultural machine among the one or more agricultural machines; and
while a second agricultural machine is performing agricultural work in the field, in response to receiving the signal from the terminal apparatus, cause the first agricultural machine to move to the field to assist in the agricultural work performed by the second agricultural machine.

3. The agricultural assistance system of claim 1, wherein the controller is configured or programmed to:
control an operation of each of a first agricultural machine and a second agricultural machine among the one or more agricultural machines; and
in response to receiving the signal from the terminal apparatus, cause the first agricultural machine and the second agricultural machine to move to the field to assist in the agricultural work for the field.

4. The agricultural assistance system of claim 2, wherein, in response to receiving the signal from the terminal apparatus, the controller is configured or programmed to cause the first agricultural machine being stopped in a storage location to move to the field, and after the agricultural work for the field is finished, cause the first agricultural machine to move to the storage location.

5. The agricultural assistance system of claim 2, wherein, in response to receiving the signal from the terminal apparatus, the controller is configured or programmed to cause the first agricultural machine being stopped in a first storage location to move to the field, and after the agricultural work for the field is finished, cause the first agricultural machine to move to a second storage location that is distinct from the first storage location.

6. The agricultural assistance system of claim 5, wherein, in response to receiving the signal from the terminal apparatus, the controller is configured or programmed to cause the first agricultural machine being stopped in the first storage location to move to the field, and after the agricultural work for the field is finished, cause the first agricultural machine to move to the second storage location being at a shorter distance from the field than a distance from the field to the first storage location.

7. The agricultural assistance system of claim 2, wherein the controller is configured or programmed to:
control an operation of a third agricultural machine among the one or more agricultural machines; and
cause the first or third agricultural machine to move to the field based on a relative positioning, at a time when the signal is received from the terminal apparatus, between: a place where the first agricultural machine is located; a place where the third agricultural machine is located; and the field.

8. The agricultural assistance system of claim 7, wherein, when the first agricultural machine is stopped in a first storage location and the third agricultural machine is stopped in a second storage location that is located at a distance from the field that is greater than a distance from the field to the first storage location, in response to receiving the signal from the terminal apparatus, the controller is configured or programmed to cause the first agricultural machine to move from the first storage location to the field.

9. The agricultural assistance system of claim 7, wherein when the third agricultural machine is stopped in a first storage location and the first agricultural machine is performing agricultural work in another field that is located at a distance from the field that is less than a distance from the field to the first storage location, in response to receiving the signal from the terminal apparatus, the controller is configured or programmed to cause the first agricultural machine to move from the other field to the field.

10. The agricultural assistance system of claim 7, wherein, when the first agricultural machine is performing agricultural work in another field that is distinct from the field and the third agricultural machine is performing agricultural work in still another field that is located at a distance from the field that is greater than a distance from the field to the other field, in response to receiving the signal from the terminal apparatus, the controller is configured or programmed to cause the first agricultural machine to move from the other field to the field.

11. The agricultural assistance system of claim 1, further comprising a storage; wherein
the controller is configured or programmed to generate a work log including at least one piece of information among contents of work, a task time, and a type of agricultural machine for the agricultural work performed by the one or more agricultural machines in the field, and to record the work log in the storage.

12. The agricultural assistance system of claim 11, wherein the controller is configured or programmed to transmit data of the work log to the terminal apparatus.

13. The agricultural assistance system of claim 11, wherein the controller is configured or programmed to calculate a rent for the one or more agricultural machines based on the work log, and transmit billing information to the terminal apparatus.

14. The agricultural assistance system of claim 1, wherein the controller is configured or programmed to manage a schedule of agricultural work to be performed by the one or more agricultural machines.

15. The agricultural assistance system of claim 14, wherein, when the controller determines that the one or more agricultural machines are to move to the field in response to receiving the signal from the terminal apparatus, the controller is configured or programmed to update a schedule of agricultural work to be performed by the one or more agricultural machines.

16. An agricultural assistance system to assist with agricultural work with an agricultural machine, the agricultural assistance system comprising:
a controller configured or programmed to control an operation of each of a first agricultural machine and a second agricultural machine; wherein
the controller is configured or programmed to:
manage a schedule of agricultural work to be performed by the second agricultural machine; and
while the second agricultural machine is performing agricultural work for the field, if it is determined that the agricultural work by the second agricultural machine is behind the schedule, cause the first agricultural machine to move to the field to assist in the agricultural work performed by the second agricultural machine.

17. A computer-implemented agricultural assistance method to assist with agricultural work with one or more agricultural machines, the agricultural assistance method causing a computer to:
control an operation of the one or more agricultural machines;
receive a signal requesting assistance in agricultural work for a field that is transmitted from a terminal apparatus; and
when receiving the signal, cause the one or more agricultural machines to move to the field to assist in the agricultural work for the field.

18. A computer-implemented agricultural assistance method to assist with agricultural work with an agricultural machine, the agricultural assistance method causing a computer to:
control an operation of each of a first agricultural machine and a second agricultural machine;
manage a schedule of agricultural work to be performed by the second agricultural machine; and
while the second agricultural machine is performing agricultural work for the field, if it is determined that the agricultural work by the second agricultural machine is behind the schedule, cause the first agricultural machine to move to the field to assist in the agricultural work performed by the second agricultural machine.
